(19) United States
(12) Patent Application Publication
(10) Pub. No.: US 2025/0347026 A1
(43) Pub. Date: Nov. 13, 2025

(54) ELECTROCHEMICAL MACHINING DEVELOPMENTS

(71) Applicant: Cummins Ltd, London (GB)

(72) Inventors: Laura Sullivan, Huddersfield (GB); Aaron Mathew Holt, Huddersfield (GB); Ivan Scott Arbuckle, Huddersfield (GB); Philip Neil Dickinson, Huddersfield (GB)

(21) Appl. No.: 18/860,432

(22) PCT Filed: Apr. 26, 2023
(86) PCT No.: PCT/GB2023/051107

§ 371 Date: Oct. 25, 2024

(30) Foreign Application Priority Data
Apr. 27, 2022 (GB) 2206140.2

(51) Int. Cl. C25F 7/00; C25F 3/16

(52) U.S. Cl. CPC C25F 7/00; C25F 3/16

(57) ABSTRACT

A mounting body for electrochemically machining a cavity of a component is disclosed. The mounting body comprises: an engagement face, at least part of an electrode and a plurality of electrode channels. The engagement face is engageable with the component to align the mounting body with the component. The at least part of an electrode is coupled to the mounting body. The plurality of electrolyte channels extend at least partway through the mounting body. Downstream ends of the plurality of electrolyte channels are distributed around the at least part of an electrode.

### CROSS-REFERENCE TO RELATED APPLICATIONS

The present application claims the benefit of priority to and is a U.S. national stage of International Patent Application No. PCT/GB2023/051107, filed Apr. 26, 2023, which claims priority to UK Patent Application No. 2206140.2, filed Apr. 27, 2022, the contents of which are incorporated herein by reference in their entirety.

### FIELD OF TECHNOLOGY

The present invention relates to a mounting body, associated methods, and a component.

Electrochemical machining is a known process that is used to remove welded joints and to polish internal passages of tubes. In the process, a positively charged workpiece forms an anode. The workpiece, or at least an exposed surface thereof, is spaced apart (to define a gap) from a negatively charged electrode, which forms a cathode. An electrolyte is pumped through the gap provided between the workpiece and the electrode. The electrolyte effectively completes the electrical circuit between the electrode and workpiece (cathode and anode respectively). Atoms are removed from the exposed surface of the workpiece as electrons cross the gap, resulting in an improved surface finish of the workpiece.

Existing electrochemical machining processes, and associated apparatuses, limit the use of the process to only some workpieces. As part of efforts to increase the range of components that electrochemical machining processes can be used with, the inventors have identified a number of other advantageous modifications to the process, and associated apparatuses.

There exists a need to overcome one or more disadvantages associated with existing arrangements, whether mentioned in this document or otherwise.

According to a first aspect of the invention there is provided a mounting body for electrochemically machining a cavity of a component, the mounting body comprising:
an engagement face engageable with the component to align the mounting body with the component;
at least part of an electrode coupled to the mounting body; and
a plurality of electrolyte channels which extend at least partway through the mounting body;
wherein downstream ends of the plurality of electrolyte channels are distributed around the at least part of an electrode.

Electrochemical machining is intended to mean a process in which an electrolyte is passed through a gap between a negatively charged tool (cathode) and a positively charged workpiece (anode) to remove material from the workpiece. The electrolyte completes an electrical circuit (interrupted by the gap between the anode and cathode) to remove material, and transport it away, from the workpiece. In this instance it will be appreciated that the component is an example of a workpiece. The electrode is an example of a tool.

The cavity may have any one of a variety of different shapes. For example, the cavity may be generally cylindrical (e.g. having a generally circular cross-section). Alternatively, the cavity may be generally cuboidal (e.g. having a generally square, or rectangular, cross-section). The cavity may have a nonlinear geometry (i.e. it may incorporate one or more bends along its extent, or length). The cavity may be a volute. Specifically, the cavity may be a volute formed in a housing of a turbomachine housing (e.g. a turbine housing or compressor housing). The cavity may be defined by an opening. The cavity may have a discharge aperture. The electrolyte may flow through the opening of the cavity, along the internal wall of the cavity, and exit via the discharge outlet. The cavity may be an internal cavity. The cavity may define a generally enclosed volume. The cavity may have an inlet and an outlet (e.g. be a through-bore).

The component may be any one of a range of different components. Examples include a manifold, turbomachine housing (e.g. a turbine housing or a compressor housing, or another variety of pump housing) or an EGR valve. The component may be a turbine housing, or compressor housing, for a turbocharger. Where the component is a compressor housing, the compressor housing may be for an eCompressor (i.e. a compressor driven by an electric motor, or generator). The eCompressor may form part of an eTurbocharger. The component may an engine component. The component may be manufactured from a range of different electrically conductive materials including, but not limited to, aluminium, cast-iron and stainless steel.

For the purposes of this document, the electrochemical machining of the cavity is intended to refer to the effective polishing of a preformed cavity. That is to say, the cavity is not created, in a solid surface for example, by the electrochemical machining process. Rather, the surface finish of an existing cavity is improved, by reducing its surface roughness, using electrochemical machining. This is owing to the fact that the electrode is inserted into a cavity, in order for the process to be carried out. Alongside the polishing, the tolerance of the cavity dimensions may also be improved by the electrochemical process.

The mounting body may form part of an electrode assembly (e.g., in which there are multiple components assembled together, such as conductive elements of an electrode, which may be able to move relative to one another). The mounting body may form part of a flexible electrode (e.g. an electrode which deforms, or flexes, as it traverses the cavity to be machined). The mounting body may, itself, define a single-piece apparatus where a complete electrode is fixedly attached to the mounting body. Irrespective of the apparatus the mounting body forms part of, the apparatus may comprise a single electrode. Alternatively, the apparatus may comprise a plurality of electrodes (e.g. a pair of electrodes). The apparatus comprising the plurality of electrodes is advantageous where there are effectively two cavities to be machined (e.g. a twin entry volute of a turbine housing). Where the apparatus comprises a plurality of electrodes, each of the electrodes may be coupled to the mounting body (i.e. there may only be a single mounting body). The electrode may be referred to as an internal electrode.

The at least part of an electrode forms part of an electrical circuit. Examples of materials that the at least part of an electrode may be manufactured from include metals. Whilst most hard-wearing metals are suitable, stainless steels, such as 300 and 400 series stainless steels, are particularly desirable owing to their corrosion resistance. 300 and 316 series stainless steels have been found to be particularly effective.

The at least part of an electrode may comprise a conductive element of a multi-part electrode. The at least part of an electrode may comprise a flexible electrode. The at least part of an electrode may comprise an entire, rigid, single-piece electrode. The at least part of an electrode may have a cross-section that varies along its extent. Described another way, the at least part of an electrode may not have a constant cross-section.

The mounting body being coupled to at least part of the electrode may otherwise be described as at least a portion of the electrode extending from the mounting body (e.g. the engagement face thereof). The mounting body may be secured in position by, for example, a mounting fixture such as a toggle clamp or a peg. Preferably, the component comprises features, such as apertures, which may themselves be used to support pegs, for example, which can be used to align the mounting body with the component. The mounting body may align the at least part of the electrode substantially centrally within the cavity. That is to say, when taken at any point along a cross-section of the cavity, the electrode, may be provided substantially centrally therein along an axis. By aligning the electrode within the cavity, a substantially continuous gap, or clearance, may be defined between the outer electrode surface and an internal wall which defines the cavity. The gap between the outer electrode surface and the internal wall of the cavity is preferably between around 3 mm and around 6 mm on radius, but may be less than around 3 mm in some instances. The mounting body may be said to provide axial and rotational alignment of the electrode relative to the component. The mounting body may be described as securing the electrode in a stationary manner.

The mounting body may be the only means by which the electrode is aligned in the cavity. Alternatively a further support may be incorporated. For example, an outer end of the electrode may be supported within the cavity by the further support. Where the component is a turbomachine housing, the further support may be provided at least partly through an axial outlet (for a turbine housing) or an axial inlet (for a compressor housing).

The mounting body may comprise a gasket, which may be a non-conductive (electrically) gasket. The non-conductive gasket may seal, or isolate, part of the component (e.g. a flange) from the electrochemical machining circuit, and process. Said part of the component may therefore not be polished, or have material eroded. The engagement face of the mounting body may indirectly engage the component to be machined where a gasket is also incorporated. That is to say, a gasket may interpose the engagement face and the component.

The electrode may be electrically coupled to the mounting body. In use, a negative charge may be applied to (part of) the mounting body (e.g. an integral busbar) in order to apply a negative charge to the electrode. The mounting body generally may therefore constitute a cathode. The electrode may be described as a projecting feature.

The electrolyte channels may extend across, or through, an entire extent of the mounting body between the engagement face and a rear face of the mounting body (e.g. between the two major faces of the mounting body). Electrolyte channels may be distributed around a perimeter of the electrode.

The plurality of electrolyte channels may comprise four electrolyte channels. The electrolyte channels may be described as discharge channels. The plurality of electrode channels may be offset from, and distributed around, a perimeter of the electrode. Downstream ends of the plurality of electrolyte channels may be described as discharge apertures. Downstream ends of the plurality of electrolyte channels may be described as entry points for electrolyte around the electrode (and into the cavity to be machined). Downstream ends of the electrolyte channels may be defined in the engagement face of the mounting body, or may be recessed relative to the engagement face. The electrolyte channels may be bores. The electrolyte channels may be inclined in a direction of electrolyte flow. Each of the plurality of electrolyte channels may be equal in volume. Electrolyte is preferably distributed equally between each of the plurality of electrolyte channels. The electrolyte channels may each define an equal effective flow area therethrough. In embodiments where the component to be machined comprises a plurality of cavities of different (e.g. non-equal) cross-sectional areas (e.g. a turbomachine housing with two volutes having different cross-sectional areas at a given point), respective arrays of electrolyte channels (e.g. downstream ends thereof) may be adjusted to provide an even (e.g. equal) flowrate of electrolyte through each cavity. That is to say, the size and/or geometry of the downstream ends (e.g. discharge apertures) of the electrolyte channels may be altered to adjust the velocity, and so mass flowrate, of electrolyte flow for that cavity.

Advantageously, incorporating a plurality of electrolyte channels distributed around the electrode results in an electrolyte flow being more evenly distributed around the electrode during electrochemical machining. This has been found to avoid undesirable flow characteristics such as regions of recirculation in which insulating hydroxides, byproducts of electrochemical machining, may otherwise be recirculated and reduce the efficiency of, or prevent, electrochemical machining from occurring in those regions.

The electrolyte channels may be referred to as an electrolyte delivery system. The distribution of electrolyte channels may be said to conform to an outer surface of the electrode (e.g. follow the outer surface of the electrode).

The downstream ends of the plurality of electrolyte channels may be evenly distributed around the electrode.

Evenly distributed encompasses the electrolyte channels defining a generally repeating pattern with equidistant spacing between adjacent electrolyte channels, save for any minor deviations to allow an urging means (e.g. a flexible element, such as a cord) to extend through the electrode (if an urging means is present). Described another way, the repeating pattern, or even distribution, may not be perfectly even, or equal, for each of the electrolyte channels, there may be minor deviations. It may be downstream ends of the plurality of apertures specifically which are evenly distributed around the electrode. The distribution may be around a perimeter of the electrode.

The even distribution is intended to encompass a continuous even distribution (e.g. downstream ends of electrolyte channels extending in a generally repeating pattern around an entire perimeter of an electrode) and a discontinuous even distribution (e.g. two series of downstream ends of electrolyte channels, provided at two sides of an electrode, evenly distributed along those two sides only).

A respective plurality, or array, of electrolyte channels may be distributed around each electrode in embodiments comprising a plurality of electrodes.

An even distribution of downstream ends of electrolyte channels has been found to desirably distribute electrolyte uniformly around the electrode, resulting in higher efficiency electrochemical machining.

The downstream ends of the plurality of electrolyte channels may be offset from the electrode.

Described another way, the downstream ends of the electrolyte channels do not extend through the electrode but instead are offset from, but still distributed around, a perimeter of the electrode.

Advantageously, offsetting the ends of electrolyte channels from the electrode has been found to reduce turbulence in the electrolyte flow and more smoothly guide electrolyte flow over, and along, the electrode outer surface.

The plurality of electrolyte channels may extend through the electrode.

The channels may extend through the electrode between an internal cavity within the electrode.

The electrolyte channels may be arcuate cavities.

Arcuate cavities is intended to refer to at least the cross section geometry of the electrolyte channels at the downstream end. In preferred embodiments downstream ends of the electrolyte channels occupy, or extend, around about a quarter of the perimeter of the electrode. As such, the combination of four electrolyte channels extends effectively around an entire perimeter of the electrode. For embodiments having n electrolyte channels, downstream ends of the electrolyte channels preferably occur around 1/n of a proportion of the perimeter of the electrode (proximate the mounting body).

Advantageously, the electrolyte channels being arcuate cavities means that flow can be smoothly directed around at least partly arcuate electrodes.

The electrolyte channels may vary in cross-sectional area from an upstream end to the downstream end.

The electrolyte channels may increase in cross-sectional area (e.g. normal to a flow direction) from the upstream end to the downstream end. Alternatively, the electrolyte channels may reduce in cross-sectional area from the upstream end to the downstream end.

Advantageously, the electrolyte channels varying in cross-sectional area means that an electrolyte conduit can be used to feed the electrolyte channels whilst the electrolyte channels guide the flow around the electrode, e.g. a perimeter thereof, to provide high efficiency electrochemical machining.

The electrolyte channels may be defined by one or more ribs.

The one or more ribs may be tapered at an upstream end. The one or more ribs may have a generally streamlined geometry at an upstream end.

Each of the electrolyte channels is preferably defined by at least two ribs. The ribs refer to generally elongate bodies of material which are comparatively thin in view of their length. At least one rib may separate each of the electronic channels from one another.

Advantageously, such geometries have been found to split (e.g. divide) the (bulk) electrolyte flow without inducing swirl and/or turbulence in the electrolyte flow. The presence of the one or more ribs also advantageously provides a higher surface area in contact with the electrolyte such that the electrolyte can be charged by the mounting body (where the electrolyte conduit is electrically connected to [e.g. integral with] the mounting body) before the electrolyte enters the cavity to be machined. This may be referred to as precharging.

Defining the electrolyte channel with ribs also provides a comparatively high effective flow area through the electrolyte channels (e.g. flow restrictions are reduced or avoided).

The one or more ribs may have a reduced cross-sectional area at an upstream end.

Advantageously, a reduced cross-sectional area at the upstream end of the one or more ribs divides and guides flow through the electrolyte channels.

The at least part of an electrode may be coupled to the one or more ribs.

The at least part of an electrode may be integral with the mounting body.

The mounting body being integral with the at least part of an electrode is intended to encompass the mounting body and a first conductive element of the electrode being manufactured as a single body. The mounting body being integral with the at least part of an electrode is also intended to encompass arrangements where the mounting body and conductive element are manufactured separately and are joined in a subsequent manufacturing step (e.g. welding). In other embodiments, the entire electrode may be integral with the mounting body (e.g. the electrode may not be formed of a plurality of conductive elements).

Advantageously, making the at least part of an electrode integral with the mounting body significantly improves the alignment of the electrode within the cavity to be machined. This is of particular advantage for electrochemical machining where the gap between the outer electrode surface and the internal wall of the cavity is an important parameter.

The mounting body may further comprise an electrolyte conduit located upstream of, and in fluid communication with, the plurality of electrolyte channels.

The electrolyte conduit may otherwise be referred to as an electrolyte supply or an electrolyte feed. The electrolyte conduit has an extent (e.g. a length) which may be axial (i.e. straight) or may incorporate one or more arcuate portions (e.g. be bent). The electrolyte conduit preferably has a circular cross-section. The electrolyte conduit may be external (e.g. a projecting, or protruding, pipe) or internal (e.g. extending within the mounting body).

The electrolyte conduit may be manufactured from an electrically conductive material. The electrolyte conduit may be manufactured from the same material as the mounting body. The electrolyte conduit may be in electrical communication with the mounting body (e.g. such that both components can be held at the same potential).

Advantageously, the electrolyte conduit provides electrolyte for the electrochemical machining process in a uniform manner to the mounting body. The electrolyte conduit may be integral with the mounting body (e.g. encompassing the electrolyte conduit being manufactured as a single component with the mounting body, and the electrolyte conduit being joined to the mounting body in a separate manufacturing process [e.g. welding]).

The electrolyte conduit may have an extent of at least around one major dimension of a cross-section of the conduit.

The extent of the electrolyte conduit may otherwise be referred to as a length of the electrolyte conduit. Where the electrolyte conduit is a circular conduit (e.g. a circular pipe), a major dimension may otherwise be referred to as a diameter, preferably an internal diameter. For a rectangular conduit, the major dimension of the cross-section is the longer of the sides of the rectangle. If the electrolyte conduit has a variable cross-section, the major diameter refers to a largest (internal) major diameter. However, the electrolyte conduit preferably has a uniform, or constant, cross-section. The extent of the electrolyte conduit may extend up until a point where the electrolyte flow is divided (e.g. upstream of electrolyte channels).

Advantageously, the electrolyte conduit having an extent at least equal to a major dimension of a cross-section of the conduit has been found to provide desirable flow-guiding properties and also provide a degree of precharging to the electrolyte where the conduit is electrically connected to the mounting body.

The electrolyte conduit may have an extent at least equal to around three, or more, major dimensions of the cross section of the conduit.

The electrolyte conduit may have an extent of at least around six major dimensions of a cross-section of the conduit.

Advantageously, the electrolyte conduit having an extent at least equal to around six major dimensions of the cross section of the conduit has been found to provide a desirable precharging effect to the electrolyte. Furthermore, an electrolyte conduit around six major dimensions in length has been found to provide a low turbulence flow of electrolyte to the electrolyte channels, resulting in high efficiency electrochemical machining.

The electrolyte conduit may have an extent equal to around six major dimensions of the cross-section of the conduit.

According to a second aspect of the invention there is provided a method of electrochemically machining a cavity of a component using the mounting body according to the first aspect of the invention, the method comprising:
coupling the mounting body to the component to align the at least part of an electrode within the cavity; and
applying a negative charge to the at least part of an electrode, and providing a flow of electrolyte through the plurality of electrolyte channels to distribute electrolyte around the at least part of an electrode and remove material from an internal wall of the cavity.

The component may be grounded to earth. Grounding the component to earth means that substantially any static is discharged from the component. Advantageously, this means that when the electrode is negatively charged, and therefore forms a cathode, the workpiece effectively forms the anode by virtue of having a greater positive charge. Grounding the component to earth, in combination with providing the electrolyte, therefore completes the circuit to facilitate the electrochemical machining of the component. The component may be connected to a positive terminal of a power supply (to define a cathode). The electrode, optionally the mounting body also, may be connected to a negative terminal of a power supply (to form an anode).

Before the mounting body is coupled to the component, the method may further comprise inserting the at least part of the electrode through the opening (e.g. inserted into the cavity). The at least part of the electrode may be said to penetrate the cavity. Inserting the at least part of the electrode along the cavity is intended to mean that the electrode passes at least partway through an extent, or length, of the cavity. The at least part of the electrode may be passed through an entirety of the cavity i.e. a distal end of the at least part of the electrode may abut an end wall, end point, or tip of the cavity. Alternatively, the at least part of the electrode may extend only partway through the cavity. That is to say, there may still be an extent of the cavity which is not occupied by the at least part of the electrode in use. The above also applies to the whole electrode more generally (e.g. beyond the at least part of the electrode).

The opening may be a circular opening or an opening having another geometry. The opening may otherwise be referred to as an aperture.

Coupling the mounting body to the component may occur by way of the mounting body engaging, directly or indirectly, the component. The mounting body may be temporarily affixed to the component using a temporary fixture. Examples include the use of pegs, which may align bores of the mounting body with corresponding bores in the component, or the use of toggle clamps to secure the mounting body to the component. In preferred arrangements, and where the component is a turbomachine housing, the mounting body may specifically engage a flange of the turbomachine housing.

Aligning the at least part of the electrode within the cavity is intended to mean that the at least part of the electrode is located, when viewed in cross-section, substantially centrally within the cavity such that a substantially continuous clearance, or gap, exists around an exterior of the at least part of the electrode and the internal wall of the cavity.

Aligning at least part of the electrode within the cavity may comprise an outer electrode surface conforming to at least part of the internal wall of the cavity (e.g. such that the outer electrode surface generally follows the profile of the internal wall for at least part of an extent of the cavity, moving from the opening towards a distal end of the cavity). As mentioned above, the overall electrode may not be placed along an entire length of the cavity in use, and so the electrode may only extend partway along the extent of the cavity. The outer electrode surface preferably conforms to an extent of the internal wall of the cavity which is substantially equal to a length of the electrode. Put another way, the electrode preferably conforms to the cavity along the entire length of the electrode.

Applying a negative charge to the at least part of the electrode is intended to mean that the at least part of the electrode is negatively charged. In other words, the electrode is the cathode in the electrochemical machining process summarised above. The negative charge may be applied by connecting the at least part of the electrode to a power supply. The power supply may a DC (direct current) power supply.

The electrode may be electrically connected to a power supply, which may be a DC power supply. The DC power supply is also readily adjustable if needed. In some embodiments, engagement between the conductive elements may electrically couple the conductive elements together such that the power supply is indirectly connected to even an outermost conductive element.

The DC power supply may have an output amperage of at least around 100 A. The DC power supply having an output amperage of at least 100 A has been found to be effective for use with an electrochemical machining process. The output amperage may be around 140 A, or around 1 kA, or around 1.5 kA or 2.5 kA. The output amperage may be up to around 5 kA.

The DC power supply may have an output voltage of at least around 10 V. It will be appreciated that the output voltage may be −10 V, depending upon which terminal of the power supply the output is taken from. The output voltage may be around 20 V, around 30 V or around 40 V. For health and safety reasons, it is desirable that the output voltage does not exceed around 50 V.

The power supply may provide around 1.5 kA at around 40V (i.e. a 60 kW power supply). The power supply may provide around 2.5 kA at around 40V (i.e. a 100 kW power supply).

Providing the flow of electrolyte may comprise pumping the electrolyte. Pumping the electrolyte may provide a stream of electrolyte. The electrolyte may be saltwater or any other fluid which provides a flow of ions. A mild acid solution is another example of a suitable electrolyte. The electrolyte may include Sodium Nitrate and/or Sodium Chloride. The concentration may range from around 15% to around 30% by volume. Where a combination of Sodium Nitrate and Sodium Chloride is included, the ratio of Sodium Nitrate to Sodium Chloride may be, for example, around 80:20, around 70:30 or around 60:40 by volume. The electrolyte may consist of 100% Sodium Nitrate at a concentration, by volume, of between around 15% and around 30%.

Pumping a flow of electrolyte through the cavity may be described as urging an electrolyte flow through the opening, along the cavity, and out of the cavity via a discharge outlet. The flow of electrolyte may suspend material removed from the internal wall, through the cavity, and out of the cavity via the discharge outlet.

Removing material from the internal wall may be referred to as polishing the internal wall. Removing material from the internal wall may otherwise be referred as reducing a surface roughness of the internal wall. Removing material from the internal wall may be referred to as improving a surface finish of the internal wall.

The component, mounting body and at least part of the electrode (optionally an entirety of the electrode) are preferably held in a fixed relationship with one another whilst electrochemical machining occurs. Described another way, there is preferably no relative movement between the mounting body, any part of the electrode and the component whilst electrochemical machining occurs.

The method is not limited to carrying out the steps in the order set out in the claim. For example, the negative charge may be applied to the electrode before the electrode is inserted through the opening and along the cavity (although, in practice, it is anticipated that the electrode will be fully inserted into the cavity before power is switched on and the charge is applied). Similarly, electrolyte may be pumped through the cavity before the electrode is inserted. With that said, the electrode may be inserted before the negative charge is applied to the electrode. Similarly, the electrolyte may be pumped through the cavity after the electrode has been inserted, and optionally after the negative charge is applied to the electrode.

The electrolyte may comprise a liquid electrolyte. The electrolyte may consist of a liquid electrolyte. The liquid electrolyte may be, for example, saltwater (e.g. water with salt dissolved therein).

The electrolyte may comprise a plurality of bodies. The plurality of bodies may be solid bodies. The electrolyte may consist of a plurality of bodies (e.g. solid bodies). The plurality of bodies may be conductive or non-conductive. For example, the electrolyte may comprise solid media (which may be conductive or non-conductive). The plurality of bodies may comprise a plurality of beads (e.g. spherical particles) or other-shaped solids (e.g. not being spherical in geometry). The plurality of bodies may be entrained in a medium, such as liquid or gas. The medium may be conductive or non-conductive. The plurality of bodies may be considered to flow, optionally by virtue of being entrained in a medium. The plurality of bodies (e.g. solid media) may be used in combination with an electrolyte fluid, or may be used in isolation (e.g. not in combination with an electrolyte fluid).

According to a third aspect of the invention there is provided a mounting body for electrochemically machining a cavity of a component, the mounting body comprising:
an engagement face engageable with the component to align the mounting body with the component; and
an electrolyte conduit configured to receive a flow of electrolyte;
wherein the electrolyte conduit has an extent of at least around one major dimension of a cross-section of the conduit; and
wherein the electrolyte conduit is electrically connected to the mounting body.

Electrochemical machining is intended to mean a process in which an electrolyte is passed through a gap between a negatively charged tool (cathode) and a positively charged workpiece (anode) to remove material from the workpiece. The electrolyte completes an electrical circuit (interrupted by the gap between the anode and cathode) to remove material, and transport it away, from the workpiece. In this instance it will be appreciated that the component is an example of a workpiece. An electrode is an example of a tool.

The cavity may have any one of a variety of different shapes. For example, the cavity may be generally cylindrical (e.g. having a generally circular cross-section). Alternatively, the cavity may be generally cuboidal (e.g. having a generally square, or rectangular, cross-section). The cavity may have a nonlinear geometry (i.e. it may incorporate one or more bends along its extent, or length). The cavity may be a volute. Specifically, the cavity may be a volute formed in a housing of a turbomachine housing (e.g. a turbine housing or compressor housing). The cavity may be defined by an opening. The cavity may have a discharge aperture. The electrolyte may flow through the opening of the cavity, along the internal wall of the cavity, and exit via the discharge outlet. The cavity may be an internal cavity. The cavity may define a generally enclosed volume. The cavity may have an inlet and an outlet (e.g. be a through-bore).

The component may be any one of a range of different components. Examples include a manifold, turbomachine housing (e.g. a turbine housing or a compressor housing, or another variety of pump housing) or an EGR valve. The component may be a turbine housing, or compressor housing, for a turbocharger. Where the component is a compressor housing, the compressor housing may be for an eCompressor (i.e. a compressor driven by an electric motor, or generator). The eCompressor may form part of an eTurbocharger. The component may an engine component. The component may be manufactured from a range of different electrically conductive materials including, but not limited to, aluminium, cast-iron and stainless steel.

For the purposes of this document, the electrochemical machining of the cavity is intended to refer to the effective polishing of a preformed cavity. That is to say, the cavity is not created, in a solid surface for example, by the electrochemical machining process. Rather, the surface finish of an existing cavity is improved, by reducing its surface roughness, using electrochemical machining. This is owing to the fact that the electrode is inserted into a cavity, in order for the process to be carried out. Alongside the polishing, the tolerance of the cavity dimensions may also be improved by the electrochemical process.

The mounting body may form part of an electrode assembly (e.g., in which there are multiple components assembled together, such as conductive elements of an electrode, which may be able to move relative to one another). The mounting body may form part of a flexible electrode (e.g. an electrode which deforms, or flexes, as it traverses the cavity to be machined). The mounting body may, itself, define a single-piece apparatus where a complete electrode is fixedly attached to the mounting body. Irrespective of the apparatus the mounting body forms part of, the apparatus may comprise a single electrode. Alternatively, the apparatus may comprise a plurality of electrodes (e.g. a pair of electrodes). The apparatus comprising the plurality of electrodes is advantageous where there are effectively two cavities to be machined (e.g. a twin entry volute of a turbine housing). Where the apparatus comprises a plurality of electrodes, each of the electrodes may be coupled to the mounting body (i.e. there may only be a single mounting body). The electrode may be referred to as an internal electrode.

The mounting body and electrolyte conduit form part of an electrical circuit. Examples of materials that the mounting body and electrolyte conduit may be manufactured from include metals. Whilst most hard-wearing metals are suitable, stainless steels, such as 300 and 400 series stainless steels, are particularly desirable owing to their corrosion resistance. 300 and 316 series stainless steels have been found to be particularly effective.

The mounting body may be secured in position by, for example, a mounting fixture such as a toggle clamp or a peg. Preferably, the component comprises features, such as apertures, which may themselves be used to support pegs, for example, which can be used to align the mounting body with the component. The mounting body may align an electrode substantially centrally within the cavity. That is to say, when taken at any point along a cross-section of the cavity, an electrode, may be provided substantially centrally therein along an axis. By aligning the electrode within the cavity, a substantially continuous gap, or clearance, may be defined between an outer electrode surface and an internal wall which defines the cavity. The gap between an outer electrode surface and the internal wall of the cavity is preferably between around 3 mm and around 6 mm on radius, but may be less than around 3 mm in some instances. The mounting body may be said to provide axial and rotational alignment of an electrode relative to the component. The mounting body may be described as securing an electrode in a stationary manner.

The mounting body may comprise a gasket, which may be a non-conductive (electrically) gasket. The non-conductive gasket may seal, or isolate, part of the component (e.g. a flange) from the electrochemical machining circuit, and process. Said part of the component may therefore not be polished, or have material eroded. The engagement face of the mounting body may indirectly engage the component to be machined where a gasket is also incorporated. That is to say, a gasket may interpose the engagement face and the component.

The mounting body may comprise an integral busbar. The busbar being integral with the mounting body encompasses the mounting body and busbar being a single component.

The busbar may comprise one or more bores which may act as sockets into which electrical connections can be received. The sockets may receive inserts, such as copper or stainless steel inserts, to aid the connection.

Advantageously, by making the busbar integral with the mounting body, the voltage drop between the busbar and the mounting body is reduced. It is desirable to keep the voltage drop low to maintain a high efficiency during electrochemical machining.

In use, a negative charge may be applied to (part of) the mounting body (e.g. an integral busbar) in order to apply a negative charge to the mounting body. The mounting body generally may therefore constitute a cathode. By virtue of the electrical connection, said negative charge is also applied to the electrolyte conduit.

The extent of the electrolyte conduit may otherwise be referred to as a length of the electrolyte conduit. Where the electrolyte conduit is a circular conduit (e.g. a circular pipe), a major dimension may otherwise be referred to as a diameter, preferably an internal diameter. For a rectangular conduit, the major dimension of the cross-section is the longer of the sides of the rectangle. If the electrolyte conduit has a variable cross-section, the major diameter refers to a largest (internal) major diameter. However, the electrolyte conduit preferably has a uniform, or constant, cross-section. The extent of the electrolyte conduit may extend up until a point where the electrolyte flow is divided (e.g. upstream of electrolyte channels).

Advantageously, the electrolyte conduit having an extent at least equal to a major dimension of a cross-section of the conduit has been found to provide desirable flow-guiding properties and also provides a degree of precharging to the electrolyte owing to the conduit being electrically connected to the mounting body. Precharging refers to the effective charging of the electrolyte before the electrolyte meets the electrode, and provides improved electrochemical machining results at an upstream end of the cavity.

The electrolyte conduit may have an extent at least equal to around three, or more, major dimensions of the cross section of the conduit.

The electrolyte conduit may be integral with the mounting body.

The electrolyte conduit being integral with the mounting body is intended to encompass the mounting body and electrolyte conduit being manufactured as a single body. The electrolyte conduit being integral with the mounting body is also intended to encompass arrangements where the mounting body and electrolyte conduit are manufactured separately and are joined in a subsequent manufacturing step (e.g. welding).

Advantageously, the electrolyte conduit being integral with the mounting body means that both components are held at the same potential, aiding the precharging effect.

The electrolyte conduit may have an extent of at least around three major dimensions of a cross-section of the conduit.

The electrolyte conduit may have an extent of at least around six major dimensions of a cross-section of the conduit.

Advantageously, the electrolyte conduit having an extent of at least around six major dimensions of the cross section of the conduit has been found to provide a desirable precharging effect to the electrolyte. Furthermore, an electrolyte conduit around six major dimensions in length has been found to provide a low turbulence flow of electrolyte to the electrolyte channels, resulting in high efficiency electrochemical machining.

The electrolyte conduit may have an extent equal to around six major dimensions of the cross-section of the conduit.

The mounting body and electrolyte conduit may be manufactured from the same material.

Advantageously, the mounting body and electrolyte conduit being manufactured from the same material means the two components can be held at the same potential more easily.

The electrolyte conduit may be axial in extent.

The electrolyte conduit having an axial extent may otherwise be described as the electrolyte conduit being straight. Electrolyte conduits in other embodiments may incorporate one or more arcuate portions (e.g. be bent).

The mounting body may further comprise at least part of an electrode coupled to the mounting body.

The at least part of an electrode may comprise a conductive element of a multi-part electrode. The at least part of an electrode may comprise a flexible electrode. The at least part of an electrode may comprise an entire, rigid, single-piece electrode. The at least part of an electrode may have a cross-section that varies along its extent. Described another way, the at least part of an electrode may not have a constant cross-section. The electrode may be described as a projecting feature.

The mounting body may further comprise a plurality of electrolyte channels that extend at least partway through the mounting body, the plurality of electrolyte channels being provided downstream of the electrolyte conduit.

The electrolyte channels may extend across, or through, an entire extent of the mounting body between the engagement face and a rear face of the mounting body (e.g. between the two major faces of the mounting body).

The plurality of electrolyte channels may comprise four electrolyte channels. The electrolyte channels may be described as discharge channels. The plurality of electrode channels may be offset from, and distributed around, a perimeter of an electrode. Downstream ends of the plurality of electrolyte channels may be described as discharge apertures. Downstream ends of the plurality of electrolyte channels may be described as entry points for electrolyte around an electrode (and into the cavity to be machined). Downstream ends of the electrolyte channels may be defined in the engagement face of the mounting body, or may be recessed relative to the engagement face. The electrolyte channels may be bores. The electrolyte channels may be inclined in a direction of electrolyte flow. Each of the plurality of electrolyte channels may be equal in volume. Electrolyte is preferably distributed equally between each of the plurality of electrolyte channels. The electrolyte channels may each define an equal effective flow area therethrough.

Advantageously, incorporating a plurality of electrolyte channels results in an electrolyte flow being more evenly distributed during electrochemical machining. This has been found to avoid undesirable flow characteristics such as regions of recirculation in which insulating hydroxides, byproducts of electrochemical machining, may otherwise be recirculated and reduce the efficiency of, or prevent, electrochemical machining from occurring in those regions.

The distribution of electrolyte channels may conform to an outer surface of an electrode (e.g. follow the outer surface of the electrode).

Downstream ends of the plurality of electrolyte channels may be distributed around the at least part of an electrode.

The electrolyte channels may be arcuate cavities.

Arcuate cavities is intended to refer to at least the cross section geometry of the electrolyte channels at the downstream end. In preferred embodiments downstream ends of the electrolyte channels occupy, or extend, around about a quarter of the perimeter of the electrode. As such, the combination of four electrolyte channels extends effectively around an entire perimeter of the electrode. For embodiments having n electrolyte channels, downstream ends of the electrolyte channels are preferably distributed around 1/n of a proportion of the perimeter of an electrode (proximate the mounting body).

Advantageously, the electrolyte channels being arcuate cavities means that flow can be smoothly directed around at least partly arcuate electrodes.

The electrolyte channels may vary in cross-sectional area from an upstream end to the downstream end.

The electrolyte channels may increase in cross-sectional area (e.g. normal to a flow direction) from the upstream end to the downstream end. Alternatively, the electrolyte channels may reduce in cross-sectional area from the upstream end to the downstream end.

Advantageously, the electrolyte channels varying in cross-sectional area means that an electrolyte conduit can be used to feed the electrolyte channels whilst the electrolyte channels guide the flow around the electrode, e.g. a perimeter thereof, to provide high efficiency electrochemical machining.

The electrolyte channels may be defined by one or more ribs.

The one or more ribs may be tapered at an upstream end. The one or more ribs may have a generally streamlined geometry at an upstream end.

Each of the electrolyte channels is preferably defined by at least two ribs. The ribs refer to generally elongate bodies of material which are comparatively thin in view of their length. At least one rib may separate each of the electronic channels from one another.

Advantageously, such geometries have been found to split (e.g. divide) the (bulk) electrolyte flow without inducing swirl and/or turbulence in the electrolyte flow. The presence of the one or more ribs also advantageously provides a higher surface area in contact with the electrolyte such that the electrolyte can be charged by the mounting body before the electrolyte enters the cavity to be machined. This may be referred to as precharging.

Defining the electrolyte channel with ribs also provides a comparatively high effective flow area through the electrolyte channels (e.g. flow restrictions are reduced or avoided).

The one or more ribs have a reduced cross-sectional area at an upstream end.

Advantageously, a reduced cross-sectional area at the upstream end of the one or more ribs divides and guides flow through the electrolyte channels.

The electrode may be coupled to the one or more ribs.

The electrode may be integral with the mounting body.

The mounting body being integral with the at least part of an electrode is intended to encompass the mounting body and a first conductive element of the electrode being manufactured as a single body. The mounting body being integral with the at least part of an electrode is also intended to encompass arrangements where the mounting body and conductive element are manufactured separately and are joined in a subsequent manufacturing step (e.g. welding). In other embodiments, the entire electrode may be integral with the mounting body (e.g. the electrode may not be formed of a plurality of conductive elements).

Advantageously, making the at least part of an electrode integral with the mounting body significantly improves the alignment of the electrode within the cavity to be machined. This is of particular advantage for electrochemical machining where the gap between the outer electrode surface and the internal wall of the cavity is an important parameter.

According to a fourth aspect of the invention there is provided a method of electrochemically machining a cavity of a component using the mounting body according to the third aspect of the invention, the method comprising:
applying a negative charge to the mounting body, and so the electrolyte conduit, and providing a flow of electrolyte through the electrolyte conduit;
precharging the electrolyte as it flows through the electrolyte conduit towards the cavity; and
expelling the precharged electrolyte into the cavity to remove material from an internal wall of the cavity.

The component may be grounded to earth. Grounding the component to earth means that substantially any static is discharged from the component. Advantageously, this means that when the mounting body and electrolyte conduit is negatively charged, and therefore forms a cathode, the workpiece effectively forms the anode by virtue of having a greater positive charge. Grounding the component to earth, in combination with providing the electrolyte, therefore completes the circuit to facilitate the electrochemical machining of the component.

The component may be connected to a positive terminal of a power supply (to define a cathode). The mounting body may be connected to a negative terminal of a power supply (to form an anode).

Before the mounting body is coupled to the component, the method may further comprise inserting at least part of an electrode through the opening (e.g. inserted into the cavity). The at least part of the electrode may be said to penetrate the cavity. Inserting the at least part of the electrode along the cavity is intended to mean that the electrode passes at least partway through an extent, or length, of the cavity. The at least part of the electrode may be passed through an entirety of the cavity i.e. a distal end of the at least part of the electrode may abut an end wall, end point, or tip of the cavity. Alternatively, the at least part of the electrode may extend only partway through the cavity. That is to say, there may still be an extent of the cavity which is not occupied by the at least part of the electrode in use. The above also applies to the whole electrode more generally (e.g. beyond the at least part of the electrode).

The component, mounting body and at least part of the electrode (optionally an entirety of the electrode) are preferably held in a fixed relationship with one another whilst electrochemical machining occurs. Described another way, there is preferably no relative movement between the mounting body, any part of the electrode and the component whilst electrochemical machining occurs.

The opening may be a circular opening or an opening having another geometry. The opening may otherwise be referred to as an aperture.

Coupling the mounting body to the component may occur by way of the mounting body engaging, directly or indirectly, the component. The mounting body may be temporarily affixed to the component using a temporary fixture. Examples include the use of pegs, which may align bores of the mounting body with corresponding bores in the component, or the use of toggle clamps to secure the mounting body to the component. In preferred arrangements, and where the component is a turbomachine housing, the mounting body may specifically engage a flange of the turbomachine housing.

The method may further comprise coupling the mounting body to the component to align the mounting body relative to the component (and, in some embodiments, align a at least part of an electrode within a cavity to be machined). Aligning at least part of an electrode within the cavity is intended to mean that at least part of the electrode is located, when viewed in cross-section, substantially centrally within the cavity such that a substantially continuous clearance, or gap, exists around an exterior of the at least part of the electrode and the internal wall of the cavity.

Aligning at least part of an electrode within the cavity may comprise an outer electrode surface conforming to at least part of the internal wall of the cavity (e.g. such that an outer electrode surface generally follows the profile of the internal wall for at least part of an extent of the cavity, moving from the opening towards a distal end of the cavity). As mentioned above, an overall electrode may not be placed along an entire length of the cavity in use, and so the electrode may only extend partway along the extent of the cavity. An outer electrode surface preferably conforms to an extent of the internal wall of the cavity which is substantially equal to a length of the electrode. Put another way, the electrode preferably conforms to the cavity along the entire length of the electrode.

Applying a negative charge to the mounting body is intended to mean that the mounting body is negatively charged. In other words, the mounting body is the cathode in the electrochemical machining process summarised above. The negative charge may be applied by connecting the mounting body to a power supply. The power supply may a DC (direct current) power supply.

The mounting body may be electrically connected to a power supply, which may be a DC power supply. The DC power supply is also readily adjustable if needed.

The DC power supply may have an output amperage of at least around 100 A. The DC power supply having an output amperage of at least 100 A has been found to be effective for use with an electrochemical machining process. The output amperage may be around 140 A, or around 1 kA, or around 1.5 kA or 2.5 kA. The output amperage may be up to around 5 kA.

The DC power supply may have an output voltage of at least around 10 V. It will be appreciated that the output voltage may be −10 V, depending upon which terminal of the power supply the output is taken from. The output voltage may be around 20 V, around 30 V or around 40 V. For health and safety reasons, it is desirable that the output voltage does not exceed around 50 V.

The power supply may provide around 1.5 kA at around 40V (i.e. a 60 kW power supply). The power supply may provide around 2.5 kA at around 40V (i.e. a 100 KW power supply).

Expelling the precharged electrolyte may be described as discharging the electrolyte, optionally through downstream ends of electrolyte channels. Providing the flow of electrolyte may comprise pumping the electrolyte. Pumping the electrolyte may provide a stream of electrolyte. The electrolyte may be saltwater or any other fluid which provides a flow of ions. A mild acid solution is another example of a suitable electrolyte. The electrolyte may include Sodium Nitrate and/or Sodium Chloride. The concentration may range from around 15% to around 30% by volume. Where a combination of Sodium Nitrate and Sodium Chloride is included, the ratio of Sodium Nitrate to Sodium Chloride may be, for example, around 80:20, around 70:30 or around 60:40 by volume. The electrolyte may consist of 100% Sodium Nitrate at a concentration, by volume, of between around 15% and around 30%.

Pumping a flow of electrolyte through the cavity may be described as urging an electrolyte flow through the opening, along the cavity, and out of the cavity via a discharge outlet. The flow of electrolyte may suspend material removed from the internal wall, through the cavity, and out of the cavity via the discharge outlet.

Removing material from the internal wall may be referred to as polishing the internal wall. Removing material from the internal wall may otherwise be referred as reducing a surface roughness of the internal wall. Removing material from the internal wall may be referred to as improving a surface finish of the internal wall.

The electrolyte may comprise a liquid electrolyte. The electrolyte may consist of a liquid electrolyte. The liquid electrolyte may be, for example, saltwater (e.g. water with salt dissolved therein).

The electrolyte may comprise a plurality of bodies. The plurality of bodies may be solid bodies. The electrolyte may consist of a plurality of bodies (e.g. solid bodies). The plurality of bodies may be conductive or non-conductive. For example, the electrolyte may comprise solid media (which may be conductive or non-conductive). The plurality of bodies may comprise a plurality of beads (e.g. spherical particles) or other-shaped solids (e.g. not being spherical in geometry). The plurality of bodies may be entrained in a medium, such as liquid or gas. The medium may be conductive or non-conductive. The plurality of bodies may be considered to flow, optionally by virtue of being entrained in a medium. The plurality of bodies (e.g. solid media) may be used in combination with an electrolyte fluid, or may be used in isolation (e.g. not in combination with an electrolyte fluid). The component may be a turbine housing or a compressor housing for a turbocharger, and the cavity may be a turbine housing volute or a compressor housing volute respectively.

A volute has a cross-section which changes along an extent, or length, of the volute. That is to say, the volute has a non-constant cross-sectional area, or shape taken normal to the length of the volute. This can otherwise be described as generally tapering.

For the compressor housing volute, the cross-section may transition from a generally smaller circle to a generally larger circle (moving from the opening to a discharge outlet). For the case of a turbine housing volute, a cross-section may transition from a generally larger rectangle to a generally smaller rectangle. It will be appreciated that the shapes are by way of example only, and that a variety of other geometries, including complex cross-sectional shapes, may otherwise be incorporated.

For a turbine housing volute, defined by a cross-section which extends along an arcuate extent of the volute, a width of the cross-section (i.e. a major dimension) may reduce from around 80 mm (proximate a turbine housing inlet) to around 15 mm (distal the turbine housing inlet). A height of the cross-section (i.e. a minor dimension) may reduce from around 100 mm (proximate a turbine housing inlet) to around 40 mm (distal a turbine housing inlet). The width of the cross-section may be taken in the axial direction. The height of the cross-section may be taken in a radial direction.

For a compressor housing volute, the cross-section may be generally circular and a corresponding diameter may reduce from around 100 mm (proximate a compressor housing outlet) to around 15 mm (distal a compressor housing outlet).

An extent, or length, of the volute may be said to be arcuate. That is to say, moving from the opening to an end point, or distal tip, of the volute, the midpoint of the cavity (i.e. a midpoint of the cross-section) is generally arcuate. The volute may be said to extend part way around the circumference of a circle. The geometry may otherwise be described as generally snail shell like, or partly spiral. The volute may also extend in a direction out of a plane of the spiral. That is to say, the volute may be spring-like, or partly helical. Put another way, the geometry along the length of the volute may be similar to that if a generally circular ring of flexible material is cut, and the two ends are urged in opposing axial directions.

The volute may be between around 250 mm and around 2000 mm in extent (i.e. length). This may correspond with a housing where the volute centreline is provided at a diameter of between around 150 mm and around 600 mm.

The turbine housing may be a twin volute housing. The turbine housing may be an asymmetric housing.

The electrode may extend through at least around 50% of an extent of the volute. The electrode extending through to at least around 50% of the extent of the volute is advantageous in that a significant proportion of the volute can be machined in the electrode chemical machining process. The electrode may extend through at least around 80% of the extent of the volute, or at least around 85% of the extent of the volute.

A distal end of the volute may not be occupied by the electrode in use. The performance benefit gained by electrochemically machining the distal end of the volute may be less than other parts of the volute, so it may be preferable that the distal end of the volute is not electrochemically machined. The electrode may terminate between around 5 and around 25 mm from a distal tip of the volute. The electrode may be described as extending towards an end of the volute tail, or tip. In some arrangements, an entire extent of the volute may be occupied by the electrode. That is to say, the electrode may extend through an entire extent of (for example) the compressor housing volute or turbine housing volute.

The electrode may be less than between around 250 mm and around 2000 mm in extent (i.e. length).

According to a fifth aspect of the invention there is provided a computer program comprising computer executable instructions that, when executed by a processor, cause the processor to control an additive manufacturing apparatus to manufacture the mounting body according to the first or third aspects of the invention.

According to a sixth aspect of the invention there is provided a method of manufacturing an electrode, or a conductive element thereof, via additive manufacturing, the method comprising:
obtaining an electronic file representing a geometry of the mounting body according to the first or third aspects of the invention; and
controlling an additive manufacturing apparatus to manufacture, over one or more additive manufacturing steps, the electrode, or a conductive element thereof, according to the geometry specified in the electronic file.

According to a seventh aspect of the invention there is provided a component comprising a cavity electrochemically machined using the mounting body according to first or third aspects of the invention and/or using the method according to the second of fourth aspects of the invention.

The component may be any component incorporating a fluid conduit, such as a manifold, EGR valve, engine block or turbomachine housing, in particular a turbine housing or a compressor housing for a turbocharger.

Where the component is a turbine housing or a compressor housing for a turbocharger, the cavity may be a turbine housing volute or a compressor housing volute respectively.

The optional and/or preferred features for each aspect of the invention set out herein are also applicable to any other aspects of the invention, where appropriate.

### BRIEF DESCRIPTION OF THE DRAWINGS

Embodiments of the present invention will now be described, by way of example only, with reference to the accompanying drawings, in which:

FIG. 1 schematically depicts a known electrochemical machining process;

FIGS. 2a and 2b are perspective views of an electrode assembly;

FIG. 3a is a perspective view of an alternative electrode in a moveable configuration;

FIG. 3b is a perspective view of the electrode of FIG. 3a transitioning to a conforming configuration;

FIGS. 3c to 3e are various views of the electrode of FIGS. 3a and b in the conforming configuration;

FIG. 4 is a cross-section view of a turbine housing with the electrode of FIGS. 2a and 2b inserted into a volute thereof;

FIG. 5 is a perspective view of a mounting body according to an embodiment of the invention;

FIGS. 6a and 6b are perspective views of a mounting body according to another embodiment;

FIGS. 6c and 6d are perspective cross-section views of the mounting body of FIGS. 6a and 6b;

FIG. 7 is a perspective cross-section view of a mounting body according to another embodiment;

FIG. 8 is a perspective view of part of a mounting body according to another embodiment;

FIG. 9 shows results of a Computational Fluid Dynamics (CFD) simulation conducted on an electrode assembly comprising the mounting body of FIG. 7

FIG. 10 shows the results of a CFD simulation conducted on a modified electrode assembly;

FIG. 11 shows the results of a CFD simulation carried out on an electrode assembly comprising the mounting body of FIG. 8;

FIGS. 12a and 12b are perspective views of an electrode assembly comprising a mounting body according to another embodiment;

FIG. 12c is a perspective cross-section view of part of the electrode assembly shown in FIGS. 12a and 12b;

FIGS. 13 and 14 show the results of CFD simulations conducted on the electrode assembly of FIGS. 12a-c;

FIGS. 15a and 15b are perspective views of an electrode assembly comprising a mounting body according to another embodiment;

FIGS. 16a to 16c are perspective views of an electrode assembly comprising a mounting body according to another embodiment;

FIG. 17 is a perspective view of an electrode assembly comprising a mounting body according to another embodiment

FIGS. 18a and 18b are perspective views of the electrode assembly of FIG. 17 installed in situ and coupled to a compressor housing;

FIG. 19 is a table of experimental data obtained using the electrode assembly of FIGS. 12a to 12c when a turbine housing is machined;

FIG. 20 is a plot of some of the data shown in FIG. 19, indicating the relationship between conduit length and surface finish;

FIG. 21 is a table of experimental data obtained using the electrode assembly of FIGS. 12a to 12c when a compressor housing is machined;

FIG. 22 is a plot of some of the data shown in FIG. 21, indicating the relationship between conduit length and surface finish; and

FIG. 23 is a plot indicating the relationship between conduit length and the Reynolds Number of electrolyte flow.

### DETAILED DESCRIPTION OF THE DRAWINGS

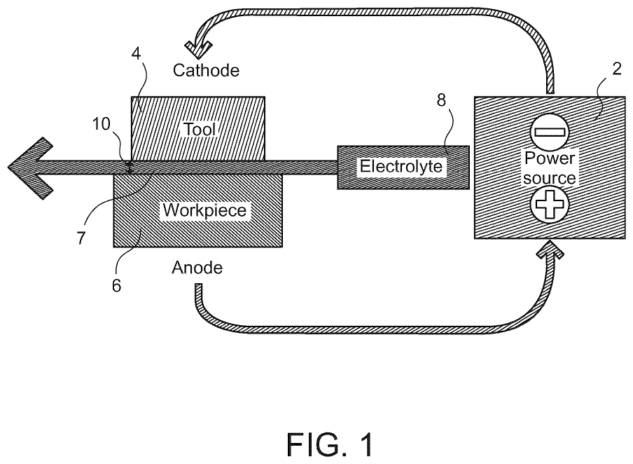

FIG. 1 is a schematic illustration of a known electrochemical machining process.

A power source 2, which may be a DC power source, is used to apply a negative charge to an electrode 4. This may be by virtue of the electrode 4 being electrically connected to a negative terminal of the power source 2. The electrode 4 therefore forms a cathode. The power source is preferably a DC power supply.

A positive charge is effectively applied to a component 6, which is to be machined, by electrically connecting the component 6 to a positive terminal of the power source 2 or, alternatively, by connecting the component 6 to ground (i.e. grounding the component). Given that the component 6 is more positively charged than the electrode 4, the component forms an anode.

A gap 10 is provided between the electrode 4 and the component 6. Specifically, the gap is provided between the electrode 4 and an electrode-facing surface 7, or exposed surface, of the component 6. The gap 10 may otherwise be referred to as a clearance.

A flow of electrolyte 8 is pumped through the gap 10 between the electrode 4 and the component 6 (specifically the electrode facing surface 7 thereof). The electrolyte flow 8 effectively completes the circuit, owing to the electrolyte being conductive. As electrons flow across the gap 10, material from an electrode facing surface 7 of the component 6 is dissolved, or removed. It will also be appreciated that material will be removed from the electrode facing surface 7 in a manner which generally conforms to the electrode 4 geometry. The electrolyte 8 then transports the removed material downstream of the component 6 and electrode 4.

The electrodes used in existing processes limit the geometries that can be machined by electrochemical machining. Specifically, given that the electrode 4 is in facing relations with the electrode-facing surface 7 of the component 6, and that a gap 10 is present in order for the electrolyte flow 8 to pass through, prior art methods and apparatuses may be unsuitable for use with more complex component geometries.

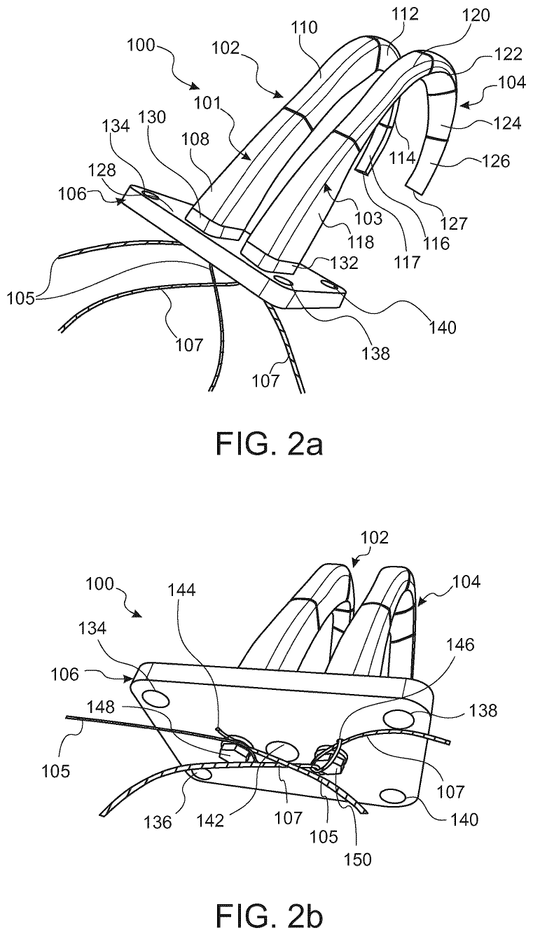

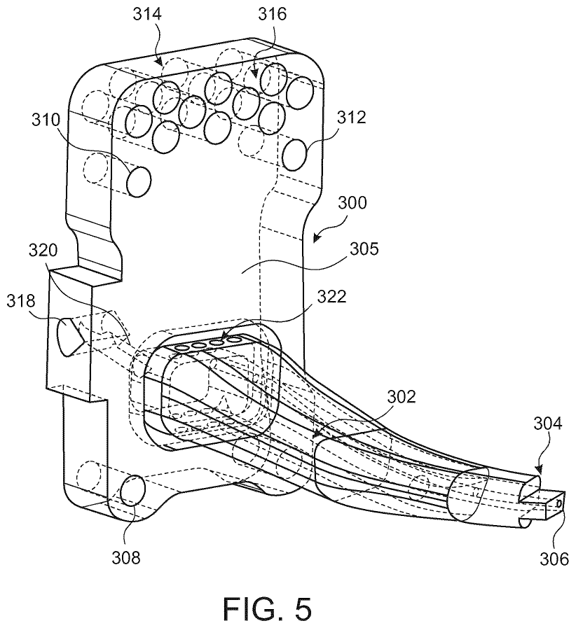

FIGS. 2a and 2b are perspective views of an electrode assembly 100. The electrode assembly 100 comprises two electrodes 102, 104, a mounting body 106 and two urging means in the form of cords 105, 107. Of note, the mounting body 106 of FIGS. 2a and 2b is not an embodiment of the present invention. However, these Figures are included to demonstrate the operation of the electrodes 102, 104, which can be used in conjunction with a mounting body in accordance with the present invention (embodiments of which will be shown in FIG. 5 onwards).

Although the illustrated electrode assembly 100 comprises two electrodes 102, 104, it will be appreciated that, in some embodiments, the electrode assembly may comprise only a single electrode.

Each of the electrodes 102, 104 comprises a plurality of conductive elements. In connection with the first electrode 102, the first electrode 102 comprises five conductive elements 108, 110, 112, 114, 116. Of note, a join line between the third and fourth conductive elements 112, 114 is obscured from view in FIG. 2a. In connection with the second electrode 104, the second electrode 104 comprises a corresponding five conductive elements 118, 120, 122, 124, 126. The fifth conductive element 116, 126 of each of the first and second electrodes 102, 104 may be referred to as an outermost conductive element owing to its position at a greatest distance, along the electrode length, from the mounting body 106. Distal ends of each of the fifth, or outermost, conductive elements 116, 126 define outermost tips 117, 127 of the electrodes 102, 104.

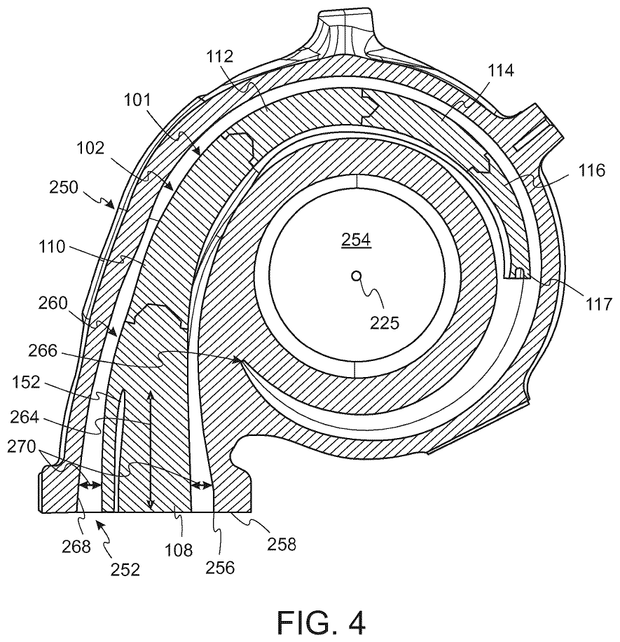

In use, the mounting body 106 engages a component to be machined to align the electrodes 102, 104 within a cavity of the component. An example of one electrode being aligned within a volute, an example of a cavity to be machined, is illustrated in FIG. 4 and will be described in detail later in this document.

Returning to FIG. 2a, the mounting body 106 takes the form of a mounting flange. The mounting flange is generally cuboidal and defines an engagement face 128 which, in use, engages a corresponding face (e.g. a flange) of a component to be machined (either directly, or indirectly via an interposing gasket, for example). Provided in the engagement face 128 are two bosses 130, 132 which project therefrom. The first conductive elements 108, 118 of the electrodes 102, 104 respectively are coupled to the mounting body 106 at the respective bosses 130, 132. The coupling may be by way of a number of different means including a bolted connection (as shown in FIG. 2b).

Also defined in the mounting body 106 are four bores 134, 136, 138, 140 (the bore 136 not being visible in FIG. 2a). The bores 134, 136, 138, 140 are used to align the mounting body 106, and so the electrodes 102, 104, with the component.

Where the component to be machined is a compressor housing, for example, the mounting body of the electrode assembly may be aligned with a generally tangential outlet of the compressor housing (as opposed to a generally tangential inlet of a turbine housing). The outlet of the compressor housing may be circular. The mounting body may align with, or engage, an internal surface and/or external surface of the compressor housing outlet. This is particularly advantageous where the compressor housing outlet does not include any mounting bores or flange, and is instead connected (in use) to a proximate conduit using a V-band clamp (for example). The compressor housing outlet may have a plain diameter. The compressor housing outlet may comprise a clip retaining feature, such as a half V-band or half marmon flange. Said feature may mate with a corresponding feature of a conduit, and the two features be secured using a V-band clamp, to connect the compressor to the conduit. Engagement of the electrode assembly with the compressor housing outlet facilitates the insertion of electrodes through the compressor housing outlet, rather than through a (for example) tangential outlet of the compressor housing.

The mounting body of the electrode assembly may be said to be engage an existing feature of the component to be machined so as to align the electrode assembly, and so electrodes, with the component and cavity.

Returning to FIG. 2a, the conductive elements, and electrodes 102, 104 more generally, have two different configurations: a moveable configuration and a conforming configuration.

In FIG. 2a the electrodes 102, 104 are shown in the conforming configuration, whereby each of the constituent conductive elements rigidly engage one or more adjacent conductive elements. When held in the conforming configuration, relative movement between the conductive elements is substantially prevented.

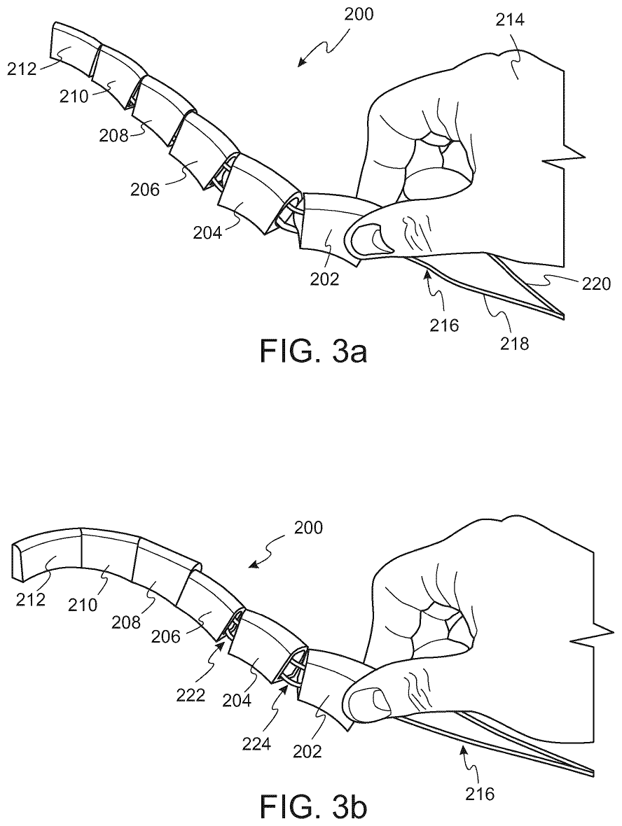

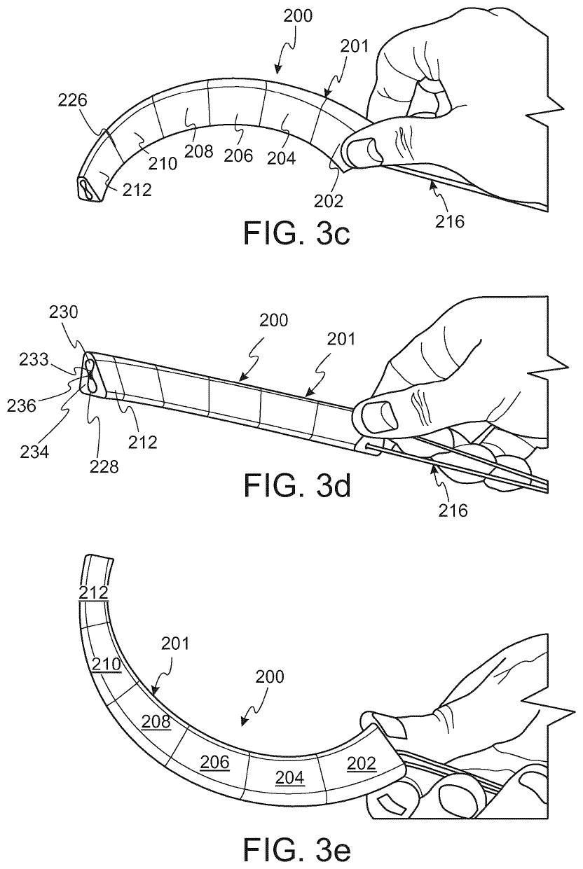

As is illustrated, in terms of the general concept, in FIGS. 3a to 3c, the conductive elements can, in a moveable configuration, move relative to one another. For example, the outermost conductive elements 116, 126 (in FIG. 2a) may be movable relative to the adjacent, fourth conductive element 114, 124.

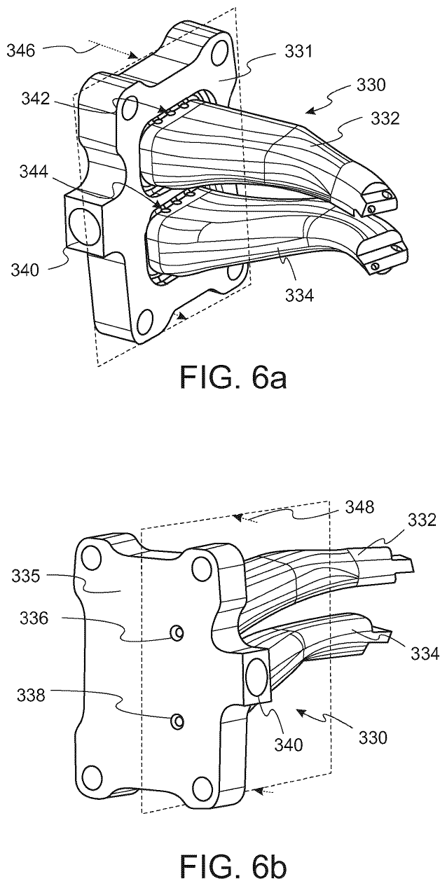

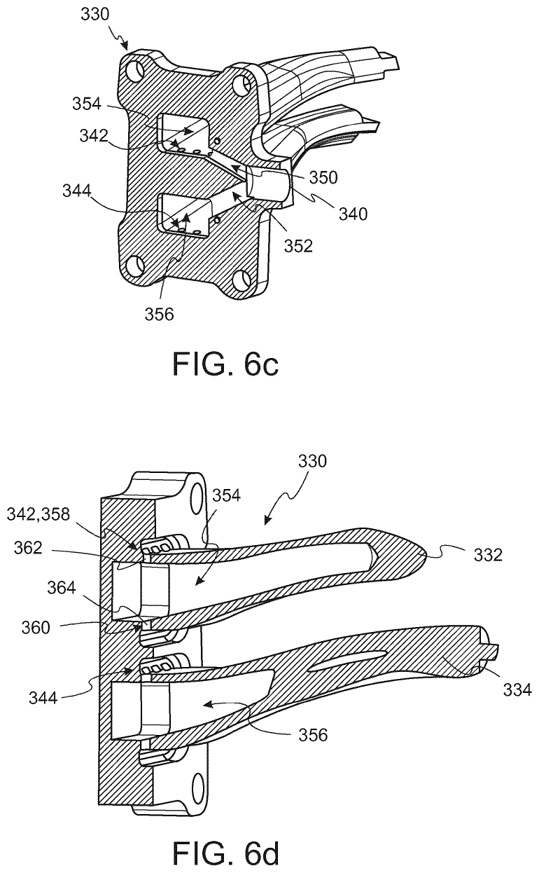

When the electrodes 102, 104 are in the moveable configuration, whereby the conductive elements are able to move relative to one another, the relative movement facilitates the insertion of the electrodes 102, 104 into cavities, and particularly to more complex cavities. For example, a volute of a turbomachine housing, such as that shown in FIG. 4, presents a comparatively challenging cavity in which to insert an electrode for use in an electrochemical machining process. However, if relative movement between the conductive elements is permitted, such as in the moveable configuration, the electrodes 102, 104 can be gradually fed into the volute whilst the conductive elements move relative to one another. The conductive elements may move relative to one another owing to interaction between an internal wall of the volute and an outer surface of the conductive elements. Once the electrodes 102, 104 are inserted sufficiently deeply into the cavity, the electrodes 102, 104 are transitioned to the conforming configuration (i.e. that shown in FIGS. 2a and 2b) such that the conductive elements of the respective electrodes 102, 104 align with one another to define a substantially continuous outer electrode surface 101, 103. Said outer electrode surface 101, 103 is then provided in facing relations with the internal wall of the cavity (e.g. 268 in FIG. 4), and provided at a substantially constant clearance, gap or offset, from the internal wall (e.g. 270 in FIG. 6). Electrochemical machining of the cavity may then occur, despite the comparatively complex geometry of the cavity.

As previously mentioned, in the illustrated embodiments the electrode assembly 100 comprises two cords 105, 107, which may be referred to as first and second cords respectively. The cords 105, 107 are examples of one variety of flexible element suitable for use with the invention. Although the following description refers to the cords 105, 107, it will be appreciated that the description applies equally to other varieties of flexible element (e.g. a wire). Each cord comprises two ends as illustrated in FIG. 2a. The cords 105, 107 extend through the conductive elements of respective first and second electrodes 102, 104. When it is desired to transition the electrodes 102, 104 to the conforming configuration (i.e. once the electrodes have been inserted into the cavity) the cords 105, 107 are actuated by way of tensioning them, in a direction away from the mounting body 106, to draw the conductive elements into engagement with one another. This is shown moving from FIGS. 3a to 3b and then to FIG. 3c. Returning to FIGS. 2a and 2b, the cords 105, 107 may then be secured such that the conductive elements, and the electrodes 102, 104 more generally, are retained in the conforming configuration. As mentioned, in the conforming configuration outer surfaces of the respective conductive elements, for each of the electrodes 102, 104, align with one another to define a substantially continuous outer electrode surface. Only minor discontinuities are provided in the outer electrode surface at joint lines between successive, or adjacent, conductive elements.

When it is desired to release, or withdraw, the electrodes 102, 104, the tension on the cords 105, 107 can be released, and the assembly 100 withdrawn by urging it away from the component. As a separation between the mounting body 106 and the component increases, the electrodes 102, 104 are gradually withdrawn from the cavity. Relative contact between outer surfaces of the electrodes 102, 104, and specifically the conductive elements thereof, may urge the conductive elements to move relative to one another to facilitate withdrawal of the electrodes 102, 104. Put another way, the conductive elements may be urged to move, relative to one another, when an outer surface of the conductive element engages the internal wall of the cavity.

It will be appreciated that, in FIGS. 2a and 2b, the first conductive elements 108, 118 remain coupled to the mounting body 106 in a fixed manner (i.e. permanently coupled and fixed relative to one another). As such, the electrodes 102, 104 may be moveable from the second conductive elements 110, 120 onwards (i.e. third, fourth conductive elements etc.). However, it will be appreciated that this may vary and more, or fewer, conductive elements may otherwise be moveable relative to one another in the moveable configuration.

Although a cord, or cords, 105, 107, are used as the urging means by which to transition the electrodes 102, 104 from the moveable to the conforming configuration, a number of other possible urging means could otherwise be used. For example, a spring and hinge system may be used to urge the conductive elements into engagement with one another. Alternatively, an electromagnet system could be used in which an electromagnet is activated to attract adjacent conductive elements and draw them towards one another. However, the cords 105, 107 provide a straightforward and convenient means of drawing the conductive elements into engagement with one another in a reliable and repeatable manner. It will also be appreciated that the illustrated plurality of cords 105, 107 may be actuated simultaneously (e.g. in a single action both cords 105, 107 may be tensioned).

Turning to FIG. 2b, an alternative perspective view of the electrode assembly 100 is provided in which the mounting body 106 is more clearly visible. As described in connection with FIG. 2a, the electrode assembly 100 comprises the first and second electrodes 102, 104 (the conductive elements not being labelled in FIG. 2b).

FIG. 2b illustrates the mounting body 106 comprising the bores 134, 136, 138, 140 which are used for aligning and/or securing the mounting body 106 to the component. The mounting body 106 further comprises an electrolyte aperture 142. The electrolyte aperture 142, as suggested by the name, is incorporated to either receive, or discharge, electrolyte therethrough. That is to say, ‘fresh’ electrolyte may be introduced through the electrolyte aperture 142 to supply electrolyte for electrochemical machining. The electrolyte aperture 142 would thus constitute an electrolyte inlet. Alternatively, ‘spent’ electrolyte may be received through the electrolyte aperture 142 after having been used in the electrochemical machining process. In such a case, the electrolyte aperture 142 constitutes a discharge outlet.

FIG. 2b also shows the mounting body 106 comprising two bores 144, 146 through which the cords 105, 107 are received. Although not visible in FIG. 2b, there are a further two bores, one associated with each electrode 102, 104, through which the other end of a respective cord 105, 107 is received. The bores, for a given cord 105, 107, preferably generally oppose one another (e.g. one bore may be located at a near 12 o'clock position, whilst the other is located at a near 6 o'clock position).

Also shown in FIG. 2b are fasteners 148, 150, in the form of bolts, which are used to secure the electrodes 102, 104 to the mounting body 106. It will be appreciated that each of the fasteners 148, 150 are received through a corresponding bore in the mounting body 106.

Turning to FIGS. 3a to 3e, the operational principle of the electrodes 102, 104 of FIGS. 2a and 2b will now be described with reference to electrode 200. The electrode 200 comprises six conductive elements 202, 204, 206, 208, 210, 212. The conductive elements are arranged in the same way as the conductive elements described in connection with the previous Figures. However, in the illustrated electrode 200, the conductive elements are comparatively shorter. Also shown in FIG. 3a is an operator's hand 214 which is used to replicate the effect of the mounting body in securing, or pinning, the first conductive element 202 in position. A cord 216, having ends 218, 220, is also shown. The cord 216 extends through each of the conductive elements.

FIG. 3a shows the electrode 200, and specifically the conductive elements thereof, in a moveable configuration. In the moveable configuration, the conductive elements are able to move relative to one another. This facilitates the insertion of the electrode 200 into a cavity, and in particular a nonlinear cavity (e.g. a volute of a turbomachine housing). For example, the outermost conductive element 212 can pivot relative to the adjacent, fifth, conductive element 210. Similarly, the fifth conductive element 210 can pivot relative to the adjacent conductive element 208, and so on. The electrode 200 therefore has a number of degrees of freedom, which means the electrode 200 can be inserted into, and extend through, nonlinear cavities. Of note, whilst the term pivot is used above, this is owing to the illustrated electrode 200 being provided on a flat surface (thus limiting some of the degrees of freedom between the conductive elements). When the electrode 200 is effectively suspended within a cavity, by a mounting body, it will be appreciated that the conductive elements have a greater number of degrees of freedom, owing to there being a clearance above, and below, the conductive elements.

In FIG. 3a, the operator's hand 214 is used to grip the first conductive element 202. As mentioned previously, the operator's hand 214 replicates the holding, or pinning, of the first conductive element 202 by the mounting body in use (see 106 in FIGS. 2a and 2b). As such, in use, and at the point where the first conductive element 202 is pinned in position, the mounting body has engaged the component (to be machined) and at least the first conductive element 202 is aligned within the component, specifically the cavity thereof. This alignment preferably takes the form of a clearance, or gap, which exists continuously around an exterior, or outer surface, of the first conductive element 202, between the exterior and the internal wall of the cavity. Put another way, there is a gap which extends around an exterior of the first conductive element 202 between the conductive element and the internal wall.

At the point where the first conductive element 202 is aligned, and it is pinned in position (i.e. by using pegs, fasteners, toggle clamps or similar), the urging means, in this example the cord 216, is then actuated to transition the electrode 200 to the conforming configuration. In the illustrated example the actuation takes the form of the user applying tension to the ends 220, 218 of the cord 216. This may otherwise be described as tensioning the cord 216. With the first conductive element 202 pinned in place, tensioning the cord 216 which, it will be recalled, doubles back on itself within the outermost conductive element 212, draws the conductive elements into engagement with one another. Put another way, the conductive elements become aligned with one another. This is indicated moving from FIG. 3a (showing the electrode in the movable configuration) to FIG. 3b and to FIG. 3c (which shows the electrode 200 in the conforming configuration).

Turning to FIG. 3b, a first stage of the transition of the electrode 200 from the moveable configuration to the conforming configuration is shown. As will be appreciated from FIG. 5b, upon (partly) tensioning the cord 216, and with the first conductive element 202 held in position, the conductive elements begin to move towards one another, towards the conforming configuration. Generally speaking, given that the cord 216 extends through each of the conductive elements and doubles back on itself within the outermost conductive element 212, the outermost conductive element 212 is first drawn into alignment with the successive, and adjacent, fifth conductive element 210. This effect generally continues between successive conductive elements until, as indicated in FIG. 3b, the fourth conductive element 208 is generally aligned with the third conductive element 206.

Due to the cord 216 only being partially tensioned in FIG. 3b, and the electrode 200 only moving towards the conforming configuration, rather than being at it, gaps 222, 224 remain between the second and third conductive elements 204, 206, and the first and second conductive elements 202, 204 respectively. These gaps 222, 224 indicate that the electrode 200 is not in the conforming configuration in that these conductive elements are not yet aligned with one another. When comparing FIG. 3b with FIG. 3a it will be appreciated that, for the conductive elements 206, 208, 210, 212 which are aligned with one another, gaps which were previously present, or could have been present, between the conductive elements have been removed moving from FIG. 3a to FIG. 3b. This may otherwise be described as the conductive elements being drawn into engagement, or alignment, with one another. For these conductive elements, it will be appreciated that respective outer surfaces of these conductive elements define a generally continuous portion of an outer surface of the electrode 200.

Turning to FIG. 3c, with a continued tensioning of the cord 216 (from FIG. 3b), the conforming configuration shown in FIG. 3c is reached. As will be appreciated by comparing FIG. 3b with FIG. 3c, the gaps 222, 224 which were present between the first, second and third conductive elements 202, 204, 206 have been removed in the FIG. 3c conforming configuration such that all of the conductive elements are aligned with one another. Outer surfaces of each of the constituent conductive elements thus defined a substantially continuous outer electrode surface 201 in FIG. 3c. The outer surfaces of each of the conductive elements 202, 204 etc. is not individually labelled in FIG. 3c, but it will be appreciated that outer surface refers to the exterior of each respective conductive element visible in FIGS. 5c to 5e. Join lines between the conductive elements are just visible in FIG. 3c. One join line between the fifth conductive element 210 and the outermost conductive element 212 is labelled 226.

Turning to FIG. 3d, a rotated perspective view of the electrode 200 in the conforming configuration is provided. The view of FIG. 3d again indicates that each of the conductive elements are aligned with one another in the conforming configuration. More detail is shown in connection with the outermost conductive element 212.

Like the outermost conductive element 116 of FIG. 2a, the outermost conductive element 212 comprises portions of passages 228, 230 which extend through the conductive elements of the electrode 200. It is through these passages 228, 230 that the cord 216 is received. An outermost portion 233 of the cord 216 is also visible in FIG. 3d. As previously described, the cord 216 doubles back on itself (i.e. in a U-shaped manner) through the outermost conductive element 212. This occurs by way of the passages 228, 230 opening out into a single opening proximate an outermost tip 234 of the outermost conductive element 212. The cord 216 extends through both passages 228, 230 and extends over a portion of material 236 which extends between, and at least partly defines, the passages 228, 230. It will be appreciated that when the cord 216 is tensioned, it is the engagement between the outermost portion 233 of the cord 216 and the portion of material 236 which effectively draws all of the conductive elements into engagement with one another (generally in succession). In other embodiments a single pass of cord may extend through only a single passage in each conductive element.

Turning to FIG. 3e, a view of an underside of the electrode 200, in the conforming configuration, is provided. Again, the FIG. 3e view illustrates that the conductive elements align with one another to define a substantially continuous outer electrode surface 201. As will be appreciated from the combination of each of FIGS. 3c, 3d, and 3e, when the electrode 200 is provided in the conforming configuration the alignment features between the conductive elements are no longer visible. That is to say, the alignment features are generally obscured by the conductive elements, and specifically the outer surfaces thereof. The conductive elements may be described as being flush with one another in the conforming configuration.

The illustrated electrode 200 is entirely arcuate in the conforming configuration, but it will be appreciated that, for example in FIGS. 2a and 2b, the electrodes may generally be a combination of linear and nonlinear (e.g. arcuate) in the conforming configuration. By comparing FIG. 3a with FIGS. 3c to 3e, it will be appreciated that the electrode 200 can be inserted into a nonlinear cavity before being transitioned to the conforming configuration such that the outer electrode surface more closely conforms to the internal wall of the cavity. This is particularly useful where the cavity is a nonlinear cavity, for example a volute of a turbomachine housing, in facilitating electrochemical machining of the internal wall.

Turning to FIG. 4, a cross-section view of a turbine housing 250 with the electrode 102 inserted therein is provided.

For illustrative reasons, and ease of reference, only the (one) electrode 102 of the overall electrode assembly 100 (of FIGS. 2a and 2b) is shown. The mounting body, and cords, are omitted. It will also be appreciated that the electrode 102 is shown in the conforming configuration. The conductive elements 108, 110, 112, 114, 116 thus align with one another, specifically outer surfaces thereof, to define the substantially continuous outer electrode surface 101. This will be described in more detail below.

Initially beginning with the turbine housing 250, as is known in the art the turbine housing 250 comprises an inlet 252 and an outlet 254. The inlet 252 is of the form of a generally tangential opening 256. Inlet 252, and opening 256, are defined in a flange 258 of the turbine housing 250. The inlet 252 is in fluid communication with the outlet 254.

The outlet 252 is a generally axial outlet. In use, after exhaust gas flow, received through the inlet 252, has been expanded across a turbine wheel it is exhausted through the outlet 254. The outlet 254 may be defined in a generally tubular outlet portion of the turbine housing 250. The turbine wheel (not shown) rotates about an axis 225. The turbine wheel is provided in the fluid path between the inlet 252 and the outlet 254.

Extending at least part way between the inlet 252 and the outlet 254 is a cavity in the form of a volute 260. The volute 260 has a generally spiralling geometry. That is to say, a radial position of a cross-section profile of the volute 260 changes, with respect to the axis of rotation 225. The volute 260 may be described as having a generally linear portion, or extent 264, and having a generally nonlinear portion beyond the linear portion 264. As will be appreciated from FIG. 4, a cross-section profile of the volute 260 varies along an extent of the volute. The cross-section profile of the volute also generally reduces in area, and changes in shape, moving from the inlet 252 to the outlet 254. The volute 260 may be described as being defined by an internal wall 268.

Returning to FIG. 4, the volute 260 comprises an outer end, or tip, 266. Although not visible from the view of FIG. 4, the outer end 266 of the volute 260 is in fluid communication with the outlet 254 via a nozzle, or throat, of the turbine housing 250. Put another way, the volute 260 opens out into the outlet 254.

As will be appreciated from FIG. 4, the volute 260 is a challenging geometry to access. Typically, turbine housings are cast using a mould, using processes such as sand casting and investment casting, to define the volute 260 cavity therein. However, such processes may not provide a desirable surface finish, particularly in applications where the surface finish may have a significant effect upon efficiency of fluid flow therethrough. Advantageously, by utilising the electrode assembly 100 described in this document, an electrochemical machining process can be used to machine, or polish, the internal wall 268 which defines the volute 260. Furthermore, this can occur along a majority, or entire, extent, or length, of the volute 260 (i.e. between the opening 256 and the outer end 266).

A method of using the electrode assembly 100 will now be described in connection with FIG. 4. It is recalled that some features of the electrode assembly 100 are not shown in FIG. 4.

Firstly, the outermost conductive element 116 of the electrode 102 is inserted through the opening 256 of the inlet 252. The electrode 102 is inserted in a moveable configuration whereby the conductive elements 108, 110, 112, 114, 116 are moveable relative to one another. The electrode 102 continues to be inserted along an extent of the volute 260 until a part of the electrode 102 contacts the internal wall 268 of volute 260. For completeness, it is appreciated that the internal wall 268 runs along an entire extent of the volute 260. That is to say, there will be a part of the internal wall 268 which defines, for example, the outer end 266 of the volute 260. Because the electrode 102 is inserted in the moveable configuration, contact between the conductive elements, such as the outermost tip 117 of the outermost conductive element 116, and the internal wall 268 leads to some movement of that conductive element to better conform to the volute 260. The electrode 102 may be said to be deflected by the internal wall 268. This effectively allows the electrode 102 to follow a nonlinear path of the volute 260 (e.g. downstream of the linear portion 264 thereof). The insertion (of the electrode 102) continues until a mounting body of the electrode assembly engages the flange 258 of the turbine housing 250. At this point, the mounting body is coupled to the flange 258, optionally with a gasket therebetween, to align the electrode 102 within the volute 260. This alignment is with reference to the electrode 102 being aligned relative to a cross-section profile of the volute 260, such that a clearance exists around the outer surface of at least the first conductive element 108 and the facing portion of the internal wall 268 of the volute 260. An example of this is shown in FIG. 4, where a gap 270 is provided around the outer surface of the electrode 102.

The urging means, such as the cord, is then actuated to transition the electrode 102 from the moveable configuration to the conforming configuration. Actuation of the urging means, e.g. tensioning of the cord, draws the conductive elements into engagement with one another such that the respective outer surfaces of the conductive elements define a substantially continuous outer electrode surface. Put another way, any gaps previously present between the conductive elements are substantially removed by drawing the conductive elements into engagement with one another. This urging effectively means that the second conductive element 110 onwards (e.g. third, fourth conductive elements 110, 112) is aligned within the volute 260 by virtue of the alignment between the mounting body and the flange 258. This provides a continuous clearance around the electrode 102 along an extent of the volute 260 that the electrode 102 reaches, or occupies (i.e. up until a position proximate the outer tip 117 of the electrode 102 in FIG. 4).

A negative charge is then applied to the electrode 102, and a flow of electrolyte is pumped through the volute 260, to commence the electrochemical machining process. The power supply which the electrode 102 is connected to may provide around 1.5 kA at around 40V (i.e. a 60 KW power supply). The power supply may provide around 2.5 kA at around 40V (i.e. a 100 KW power supply). The machining process removes material from the internal wall 268 of the volute 260. This process can effectively be used to improve a surface finish (e.g. reduce a surface roughness) and/or improve the tolerance of manufacture of the volute of 260 (e.g. the dimensions of the volute 260). The turbine housing 250 is also grounded to earth such that a positive charge is then effectively applied to it relative to the negatively charged electrode 102. However, in other embodiments the turbine housing 250 may otherwise be electrically coupled to a positive terminal of the power supply. The process described in connection with FIG. 1 then occurs.

Specifically, the electrode 102 (specifically conductive elements 108 onwards) forms a cathode, and the internal wall 268 of the volute 260 forms the anode. The clearance between the outer surface of the electrode 102 and the internal wall 268 reduce the risk of arcing, or short circuiting, occurring between the electrode 102 and the internal wall 136 (which could otherwise lead to a poor surface finish and other issues with the machining process). The flow of electrolyte effectively completes the circuit and, as electrons pass across the electrolyte and are absorbed by the internal wall 136, material is removed from, or vaporised from, the internal wall 268. The electrolyte flow further transports any material which is removed and discharges the waste material through a corresponding outlet. It will be appreciated that the electrolyte flow may be pumped through either the inlet 252 in a direction towards the outlet 254, or may be pumped into the outlet 254 and discharged through the inlet 252. Either way, electrolyte may pass through the electrolyte aperture 142 shown in FIG. 2b.

Once the electrochemical machining has occurred, the urging means may then be released such that the electrode 102 can transition to the moveable configuration. The mounting body may then be decoupled from the flange 258 and the assembly withdrawn from the volute 260. In a similar fashion to the way that the conductive elements conformed to the volute 260 upon insertion, upon contact between a conductive element and the internal wall 268 during removal, or withdrawal, of the electrode 102, the electrode 102 is effectively able to move, to better conform to the volute 260 geometry to facilitate removal thereof. Put another way, the electrode 102 is deflected by contact with the internal wall 268 to aid in the removal of the electrode 102, and prevent the electrode 102 being stuck in the volute 260.

The electrolyte may be saltwater or any other fluid (optionally with a plurality of bodies entrained therein) which provides a flow of ions. A mild acid solution is another example of a suitable electrolyte. The electrolyte may include Sodium Nitrate and/or Sodium Chloride. The electrolyte may comprise (or consist of) a liquid electrolyte. The electrolyte may comprise a plurality of bodies (e.g. solid bodies) which may be conductive or non-conductive. The plurality of bodies may be entrained in (e.g. suspended in) a medium, such as liquid or gas. The medium may be conductive or non-conductive. Alternatively, the electrolyte may consist of a plurality of (conductive) bodies (e.g. a solid media) in isolation of a fluid electrolyte. An example of a plurality of bodies is a solid media, which may be conductive or non-conductive. The plurality of bodies may comprise beads (e.g. spherical particles) and/or non-spherical particles. A plurality of bodies (e.g. solid media), optionally suspended in a medium, may therefore provide an electrolyte for use in accordance with the present invention.

For completeness, although only a single volute 260 is shown in the turbine housing 250 of FIG. 4, the turbine housing 250 is a twin entry turbine housing. That is to say, the turbine housing 250 comprises a pair of volutes. The volutes generally follow the same profile. The electrode assembly illustrated in connection with the earlier Figures is particularly advantageous for such twin volute arrangements, whereby one electrode is received in each of the two volutes. The volutes may thus be machined simultaneously, and using a single electrolyte supply. However, it will also be appreciated that turbine housings comprising only a single volute may equally be machined using electrochemical machining. In such examples, the electrode assembly may also comprise only one electrode.

Although the above has been described with reference to a turbine housing volute, it will be appreciated that there are a range of other components, and cavities therein, which could be advantageously machined using the electrochemical machine process and the electrode assembly described herein. Once such alternative is a volute of a compressor housing, which has a generally similar geometry to the turbine housing volute shown in FIG. 4, although there are some geometric differences (e.g. the cross-section of the volute is generally circular, and preferably varies in area in a linear manner). Other components include valves, manifolds (e.g. exhaust manifolds) and any other component which has a comparatively complex cavity. Examples of comparatively complex cavities include cavities which follow an at least partly nonlinear path, such as an at least partly arcuate cavity.

Further examples of comparatively complex cavities include cavities comprising a stagger or dog-leg-type arrangement. The cavity may have a generally tubular structure.

For completeness, FIG. 4 also shows part of a passage 152, for receiving a cord therein, of the first conductive element 108. The part of the passage 152 is visible, and the other passage is not visible, because of the nonlinear fashion in which the passages extend through the first conductive element 108 (see FIGS. 3a and 3b).

As part of ongoing research and development of the abovementioned electrochemical machining method and apparatus, as well as other apparatuses (as described in more detail later in this document), the inventors have devised a number of improvements to the method and apparatus. The developments relate to the distribution/uniformity of electrolyte flow around the electrode, which has been found to have a significant effect upon the quality of electrochemical machining. The developments also relate to the precharging of electrolyte before it reaches the abovementioned electrode(s).

The inventors have implemented the aforementioned developments by modifying the mounting body, as described in detail below.

Turning to FIG. 5, a perspective view of a mounting body 300 according to an embodiment of the invention is provided. The mounting body 300 shares a number of features in common with the mounting body previously described, and only the differences will therefore be described in detail.

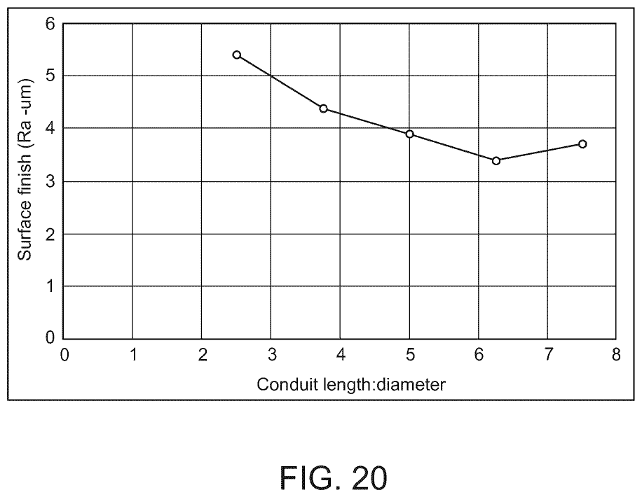

The mounting body 300 comprises an integral first conductive element 302. Described another way, the mounting body 300 and first conductive element 302 are unitary in nature and are manufactured as a single component. This has been found to be particularly advantageous for ensuring accurate alignment of the overall electrode, of which the first conductive element 302 forms part, within the cavity to be machined. At a second end 304 of the first conductive element 302, generally distal an engagement face 705 of the mounting body 300, a projection 306 is present (like that described in connection with FIG. 20).

The mounting body 300 comprises four bores 308, 310, 312 (a fourth being hidden from view in FIG. 5) which are used for aligning the mounting body 300 with a component to be machined.

The mounting body 300 further comprises an integral busbar 314. The busbar 314 being integral is intended to mean that the mounting body 300 and busbar 314 are all a single component. This busbar 314 effectively refers to an additional block of material and, in the illustrated embodiment, the busbar 314 comprises an array 316 of additional bores. In the illustrated embodiment the array 316 comprises ten bores. The constituent bores of the array 316 operate as sockets into which power supply cables are inserted in use. A power supply is thus provided in electrical communication with the electrode, of which the first conductive element 302 forms part, via the mounting body 300. In use, conductive inserts, such as copper or stainless steel inserts, may be inserted into the bores which make up the array 316 of bores. Advantageously, the integral busbar 314 reduces the voltage drop between the mounting body and conductive elements of the electrode. This is achieved by effectively removing an interface (e.g. a point of electrical connection) which would otherwise be present between the busbar and the electrode (for example). Efficiency of the overall electrochemical machining process is thus improved. For completeness, each interface (e.g. between adjacent conductive elements) may cause a corresponding voltage drop, which may be around 2-3 V (for example). For a 30V power supply, the voltage drop at each interface could therefore represent ˜10% of the supply voltage. Furthermore, each interface is a potential point of failure. It is therefore desirable to reduce the number of interfaces, or connections, where possible.

The mounting body 300 further comprises an electrolyte aperture 318. In the illustrated embodiment the electrolyte aperture 318 is configured to receive electrolyte therethrough. The electrolyte aperture 318 extends partway through the mounting body 300. A connecting channel 320, formed within the mounting body 300, is provided downstream of the electrolyte aperture 318. The combination of the electrolyte aperture 318 and the connecting channel 320 may be said to define an elbow given that there is a change of direction, substantially 90°, of the electrolyte as it passes therethrough. Although not shown in detail in FIG. 5, but will be described in detail in connection with later Figures, the connecting channel 320 opens out into an internal cavity within the first conductive element 302. An array of electrolyte channels 322, which may be referred to as discharge channels, are distributed around the first conductive element 302. Specifically, the electrolyte channels 322 extend through the first conductive element 302 (i.e. from the internal cavity through to an outer surface). In preferred embodiments at least downstream ends of the electrolyte channels 322 are distributed around the electrode. More detail regarding the electrolyte channels will be provided in connection with later Figures. Downstream ends of the electrolyte channels 322 extend only partway around the conductive element 302 (e.g. are distributed around a proportion of the perimeter of the conductive element).

It will be appreciated that the distribution of electrolyte channels 322 is advantageous in isolation of, and in combination with, the integral busbar 314 and the integral first conductive element 302. The advantages associated with the distribution of electrolyte channels 322 are applicable to a wider range of electrodes than the hingeably connected electrode shown in the illustrated example (as will be described in detail below).

The mounting body 300 is preferably manufactured using an additive manufacture method.

Turning to FIGS. 6a and b, perspective views of a mounting body 330 according to another embodiment is illustrated. FIG. 6a shows the mounting body 330 from an engagement-face 331 side of the mounting body 330 (e.g. proximate the cavity to be machined). FIG. 6b shows a generally opposing (e.g. rear) side of the mounting body 330.

The mounting body 330 shares a number of features in common with the mounting body 300 shown in FIG. 5. Only the differences will therefore be described in detail.

The mounting body 330 comprises a plurality of (integral) first conductive elements 332, 334. The mounting body 330 does not incorporate an integral busbar.

FIG. 6b shows an additional two bores 336, 338 in the rear face 335 of the mounting body 330. The bores 336, 338 are configured to receive respective cords therethrough such that, upon tensioning the cords, downstream conductive elements are drawn into alignment with one another (e.g. the electrodes are transitioned to the conforming configuration). The bores 336, 338 may receive glands in use, through which cords are received.

The mounting body 330 further comprises an electrolyte aperture 340.

FIG. 6a shows two arrays 342, 344 of electrolyte channels, distributed about perimeters of the respective first conductive elements 332, 334. As previously described, in use electrolyte is discharged, or expelled, through the electrolyte channels around an outer electrode surface of the electrodes.

Turning to FIGS. 6c and 6d, perspective cross-section views of the mounting body 330 are provided. FIG. 6c is taken about the cross-section labelled 346 in FIG. 6a, and FIG. 6d is taken about the cross-section labelled 348 in FIG. 6b.

Beginning with FIG. 6c, as indicated in FIG. 6a the cross-section is taken about a thickness of the mounting body 330. FIG. 6c shows the electrolyte aperture 340 extending partway through the mounting body 330 and splitting into two connecting channels 350, 352.

Downstream ends of each of the first and second connecting channels 350, 352 open out into respective first conductive element cavities 354, 356. The cavities 354, 356 refer to an internal volume within each of the first conductive elements 332, 334 respectively. As will be appreciated from FIG. 6d, the cavities 354, 356 extend partway through the first conductive elements 332, 334 respectively. The cavities 354, 356 advantageously reduce the mass of the mounting body 330, and provide a fluid pathway for electrolyte to flow through.

Returning to FIG. 6c, the first and second arrays 342, 344 of electrolyte channels extend between the cavity 354, 356 and the exterior surface of the first conductive elements 332, 334. When the mounting body 330 is coupled to a component to be machined, and the electrode(s) extends through the cavities to be machined, electrolyte is pumped through the electrolyte aperture 340, through one of the first and second connecting channels 350, 352 into a respective conductive element cavity 354, 356 and is then discharged by the respective array of electrolyte channels 342, 344. The electrolyte is discharged through the arrays 342, 344 of electrolyte channels into a gap between an internal wall of the cavity to be machined and an outer electrode surface of the electrodes (e.g. including the first conductive elements 332, 334).

Turning to FIG. 6d, the layout of the electrolyte channels will now be described in more detail. FIG. 6d illustrates that the first array 342 of electrolyte channels includes electrolyte channels generally arranged at two opposing sides of a perimeter of the first conductive element 332. Described another way, as shown in FIG. 6d electrolyte channels are only provided through generally upper and lower sides of the first conductive element 332. Where the first conductive element 332 has a generally rectangular cross section, the electrolyte channels may be described as only being provided along one pair of parallel sides.

Beginning with the first array 342 of electrolyte channels, the first array 342 comprises first and second series 358, 360 of electrolyte channels. The first and second series 358, 360 of electrolyte channels are provided at opposing sides of the first conductive element 332 whilst the other pair of opposing sides are free of electrolyte channels. Described another way, two of the sides are generally solid with no channels, whilst two of the sides do comprise channels. Two electrolyte channels are labelled 362, 364 respectively and form part of the first and second series 358, 360 of electrolyte channels respectively. Each of the electrolyte channels extends generally normally through a thickness of the first conductive element 332 (i.e. at a right angle through the internal and external surfaces of the conductive element 332).

Advantageously, the inventors have found that providing a distribution of electrolyte channels around the electrode provides for an improved distribution of electrolyte flow around the electrode during electrochemical machining. This, in turn, results in improved electrochemical machining efficiency by virtue of a more even removal of material from the internal cavity which is being machined.

Although not described in detail here, the other first conductive element 334 also comprises the array 344 of electrolyte channels which comprises first and second series provided generally at opposing sides of the first conductive element 334. The above description, in connection with the array 342, applies equally to the array 344.

Wherever electrolyte is flowing through: 1) a channel, or conduit, of a mounting body which is electrically connected to at least part of an electrode (e.g. where a first conductive element is integral with the mounting body); and 2) the channel, or conduit, is upstream of the electrode (e.g. a first conductive element thereof), the electrolyte is effectively precharged before the electrolyte meets the electrode. Described another way, ions within the electrolyte become charged. This is advantageous, for reasons described in detail later in this document, for the reason that the machining action by the electrolyte occurs more effectively at an upstream end of the cavity to be machined.

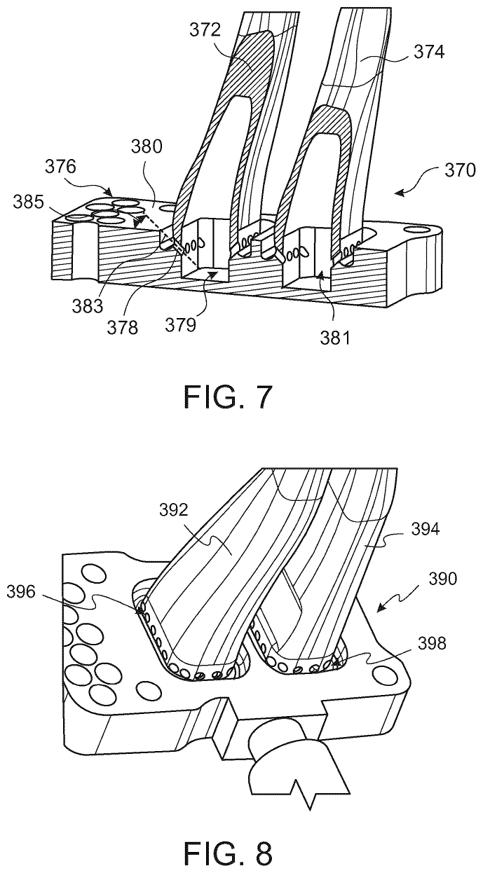

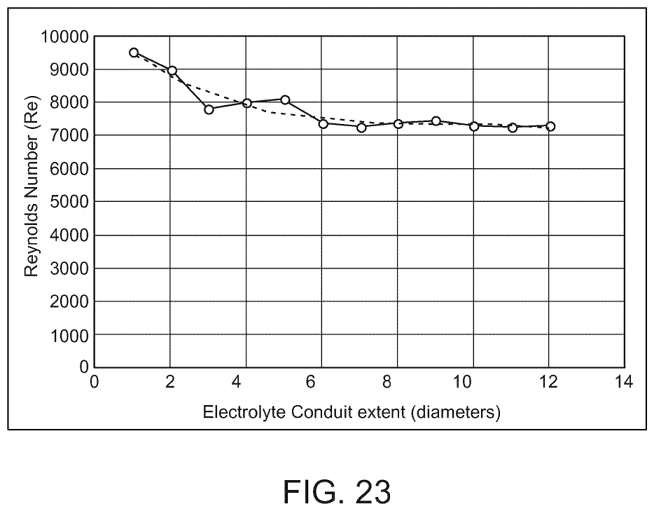

Turning to FIG. 7, a cross-section view of a further embodiment of mounting body 370 is illustrated. The mounting body 370 shares a number of features in common with the mounting body 300 of FIG. 5 and the mounting body 330 of FIGS. 23a to d. Only differences will be described in detail.

The mounting body 370 comprises integral first and second conductive elements 372, 374. Furthermore, the mounting body 370 comprises an integral busbar 376.

Unlike the previous embodiments, electrolyte channels are not disposed normal to a thickness of the first conductive elements 372, 374 but are angled (e.g. inclined). The electrolyte channels thus more smoothly guide electrolyte in a direction that the cavity to be machined extends in. Described another way, the electrolyte channels guide electrolyte flow around, and along, the first conductive elements 372, 374. In the illustrated embodiment, and taking a first electrolyte channel 38378 as an example, the electrolyte channels are angled in a downstream direction. That is to say, the electrolyte channels are angled with a direction of flow through the cavities 379, 381 and into the internal cavity to be machined. The electrolyte channels 38378 may be said to define an axis 383, the axis 383 defining an angle 385 with an engagement face 380 of the mounting body 370. The angle 385 is preferably acute. In the illustrated embodiment the angle 385 is around 45 degrees.

The flow of electrolyte through the various channels and cavities also provides an advantageous cooling effect upon the electrode.

Electrolyte channels of the mounting body 370 are only disposed along two opposing sides of each of the first conductive elements 332, 334. The two other sides remain solid and do not comprise any electrolyte channels. The electrolyte channels are bores in the illustrated embodiment (i.e. circular in cross-section and are straight in extent) but in other embodiments other geometry and/or shapes may be employed.

Turning to FIG. 8, a perspective view of part of a mounting body 390 according to another embodiment is provided. The mounting body 390 shares a number of features in common with the mounting body 370 shown in FIG. 7, and only the differences will be described in detail.

First conductive elements 392, 394 are integral with the mounting body 390, as is a busbar. First and second arrays 396, 398 of electrolyte channels extend around the perimeters of each of the first conductive elements 392, 394 respectively. Unlike the mounting body 370 shown in FIG. 7, for the mounting body 390 each of the arrays 396, 398 of electrolyte channels extend continuously around the perimeters of the first conductive elements 392, 394. Described another way, electrolyte channels are provided through each side of the conductive elements 392, 394 (i.e. there are no sides of the conductive elements 392, 394 which have no electrolyte channels). The distribution of electrolyte channels may be described as equal distribution around the (entire) perimeters of the conductive elements 392, 394 in that the electrolyte channels define a generally repeating pattern with equidistant spacing between adjacent electrolyte channels. This is generally the case save for any minor deviations to allow for the urging means (i.e. a flexible element, such as a cord) to extend through the conductive elements 392, 394. Described another way, the repeating pattern, or even distribution, may not be perfectly even, or equal, for each of the electrolyte channels, there may be minor deviations.

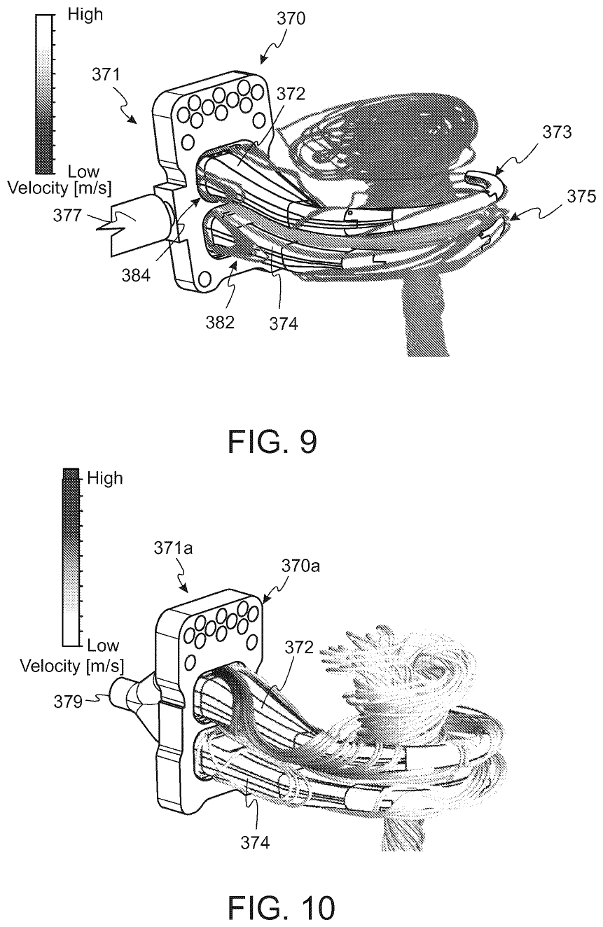

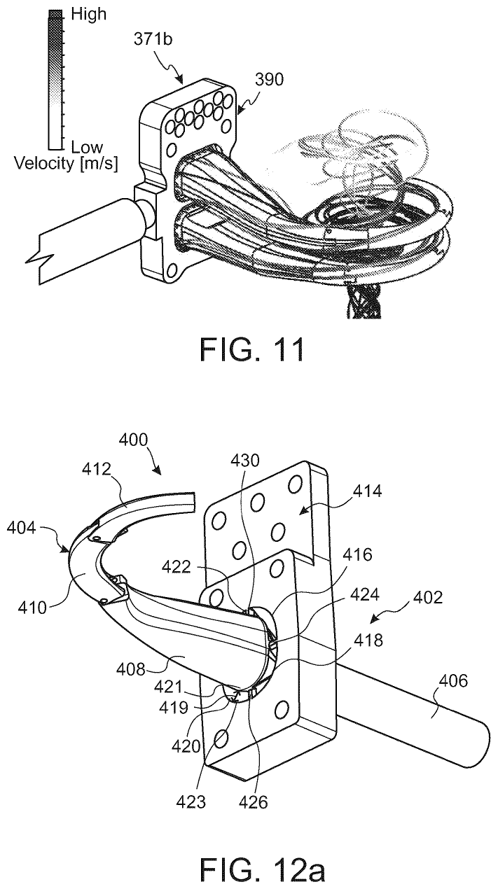

Turning to FIG. 9, the results of a Computational Fluid Dynamics (CFD) simulation conducted on an electrode assembly 371 comprising the mounting body 370 of FIG. 7 are provided. FIG. 9 is a velocity plot showing the contours, and velocity, of electrolyte having passed through the mounting body 370 and along first and second electrodes 373, 375 of which first conductive elements 372, 374 form part. Hidden from view in FIG. 9 is a turbine housing into which the first and second electrodes 373, 375 are inserted. Similarly, the pair of turbine housing volutes, which are the cavities being machined by way of electrochemical machining, are also hidden from view. A representative housing is indicated in FIG. 11 for completeness.

Returning to FIG. 9, the electrode assembly 371, specifically the mounting body 370 thereof, comprises an electrolyte conduit 37377. In use, electrolyte is supplied to the mounting body 370 via the electrolyte conduit 37377. From FIG. 9 it will be appreciated that the electrolyte conduit 37377 is generally provided at a right angle (e.g. an elbow joint) to a thickness of the mounting body 370.

The CFD results shown in FIG. 9 indicate regions 382, 384 of comparatively high recirculation of electrolyte proximate a downstream end of the electrolyte channels (i.e. near where the electrolyte first exits the mounting body 370 by the first conductive elements 372, 374). In particular, the regions of high recirculation 382, 384 occur on the sides of the conductive elements 372, 374 which do not incorporate any electrolyte channels. Although not visible in FIG. 9, similar results are observed on the opposing sides of the first conductive elements 372, 374. Similarly, from the velocity plot it will be appreciated that the electrolyte flow velocity is comparatively lower around the first electrode 373 in comparison to the second electrode 375. Described another way, the electrolyte velocity is generally higher moving around the lower of the electrodes in comparison to the upper electrode.

Regions of recirculating electrolyte have been found to be undesirable for at least the reason that a continuous flow of fresh electrolyte along the electrodes 373, 375 results in the most efficient, and uniform, electrochemical machining. Whilst electrochemical machining occurs, insulating hydroxides are formed as byproducts of the process (e.g. in the form of a viscous slurry). As suggested, the insulating nature of the hydroxides negatively impact electrochemical machining by reducing the efficiency of machining, or entirely preventing it, in the regions of the internal wall of the cavity which are effectively shielded by these insulting hydroxides. During normal operation, such hydroxides are flushed by the continuous pumping of electrolyte through the cavity being machined. Regions of electrolyte flow recirculation 382, 384 can result in regions of the internal cavity being machined at significantly lower rates than others (i.e. as much of a difference as three times the magnitude of machining). This is at least partly due to hydroxides being suspended, rather than ‘flushed’, by electrolyte. More generally, turbulence within the electrolyte flow is undesirable.

Turning to FIG. 10, the results of a CFD simulation conducted on a modified electrode assembly 371a are provided. The modified electrode assembly 371a shares many features in common with the electrode assembly 371 of FIG. 9 other than an electrolyte conduit 379 is a generally straight feed conduit. Described another way, the electrolyte conduit 379 does not extend generally normal to a thickness of the mounting body 370a but instead generally extends normal to major faces (i.e. the engagement face and opposing face) of the mounting body 370a.

As a result of this difference in orientation of the electrolyte conduit 379, the electrolyte fed through the electrolyte conduit 379 has fewer, and less extreme, changes of direction in comparison to the generally right-angled electrolyte conduit 37377 of FIG. 9. When the CFD results of FIGS. 26 and 27 are compared, it will be appreciated that, in FIG. 10, the flow is more evenly distributed around the conductive elements 372, 374, and that the recirculation zones 382, 384 of FIG. 9 have been reduced. However, some recirculation remains in similar zones at sides of the conductive elements 372, 374 at which there are no electrolyte channels. In short, the incorporation of a generally straight feed electrolyte conduit 379 has improved the flow characteristics and would therefore improve the efficiency of electrochemical machining, but it is still desirable to obtain a more uniform flow distribution around the conductive elements 372, 374 of the respective electrodes.

FIG. 11 shows the results of a CFD simulation carried out on an electrode assembly 371b comprising the mounting body 390 of FIG. 8 (e.g. where downstream ends of the electrolyte channels are generally evenly, and continuously, distributed around the electrodes).

When FIGS. 9 and 11 are compared, it will be appreciated that distributing downstream ends of the electrolyte channels around an entire perimeter of the electrode(s) (e.g. a generally even distribution) reduces the recirculation of electrolyte within the cavity being machined.

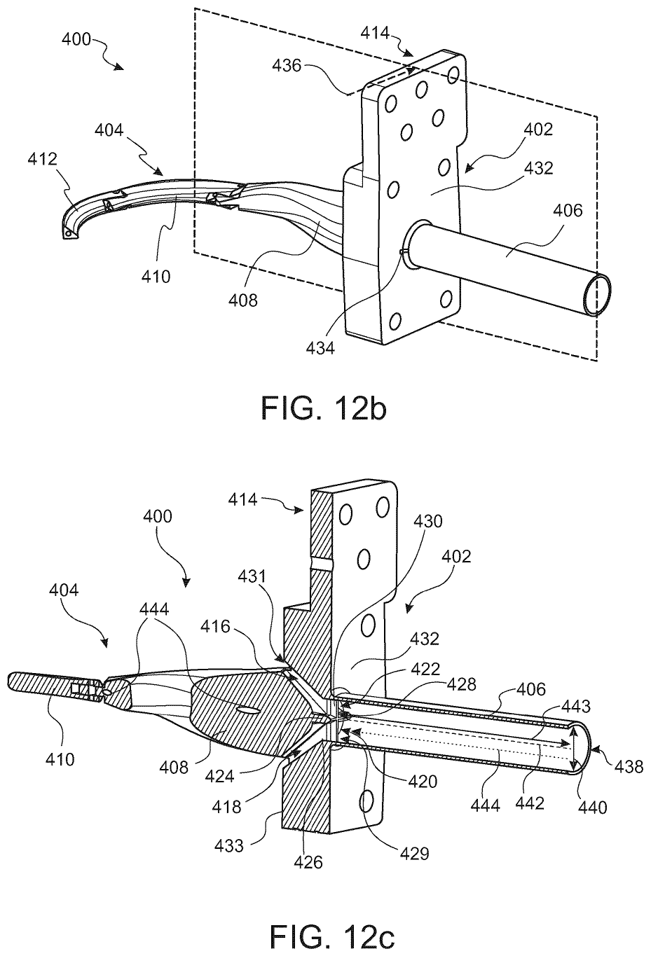

FIG. 12a is a perspective view of an electrode assembly 400 according to another embodiment.

The electrode assembly 400 comprises a mounting body 402, a first electrode 404 and an electrolyte conduit 406.

As previously described elsewhere in this document, the first electrode 404 comprises first, second and third conductive elements 408, 410, 412. The conductive elements 408, 410, 412 are hingeably connected to one another. For the avoidance of doubt, the electrode 404 is shown in the moveable configuration, in which the conductive elements 408, 410, 412 are moveable relative to one another, but the electrode 404 can be transitioned to a conforming configuration in which the conductive elements 408, 410, 412 align with one another to define a substantially continuous outer electrode surface. The first conductive element 408 is coupled to, and is integral with, the mounting body 402. The mounting body 402 also comprises an integral busbar 414.

Provided through the mounting body 402 are a plurality of electrolyte channels, which may be referred to as discharge channels, through which electrolyte can flow. First to fourth electrolyte channels 416, 418, 420, 422 are distributed around the first conductive element 408 of the electrode 404. The plurality of electrolyte channels 416, 418, 420, 422 may be referred to as an array of electrolyte channels. The electrolyte channels are defined by ribs 424, 426, 430 (one of the ribs not being shown in FIG. 12a) which may be described as extending between the electrolyte channels 416, 418, 420, 422. More detail regarding the electrolyte channels will be provided in connection with FIG. 12c which shows a cross-section view through the electrode assembly 400.

The mounting body 802 is preferably manufactured using an additive manufacture method.

FIG. 12b is a perspective view of the electrode assembly 400 from a generally rear side of the assembly. FIG. 12b shows the electrolyte conduit 406 extending from a rear face 432 of the mounting body 402. In the illustrated embodiment the electrolyte conduit 406 extends substantially perpendicular to the rear face 432 of the mounting body 402. Described another way, the electrolyte conduit 406 is substantially normal to the rear face 432 of the mounting body 402. The electrolyte conduit 406 is an external conduit owing to the fact that it projects from the rear face 432 of the mounting body 402 (as opposed to, for example, extending internally within the mounting body 402). The electrolyte conduit 406 has a circular cross-section in the illustrated embodiment, although it will be appreciated that other cross-section geometries may otherwise be used. The electrolyte conduit 406 is manufactured from the same material as the rest of the mounting body 402 in the illustrated embodiment (e.g. 316L stainless steel, although other materials may otherwise be used). The electrolyte conduit 406 is also integral with the mounting body 402. Described another way, the electrolyte conduit 406 may be manufactured in a unitary manner with the rest of the mounting body 402 (i.e. such that they form a single component with no join lines). Otherwise, and still considered integral, the electrolyte conduit 406 may be connected to the mounting body 402 in a subsequent manufacturing step, e.g. welding. In the illustrated embodiment the electrolyte conduit 406 is TIG welded to the mounting body 402 (specifically a rear face 432 thereof).

The electrolyte conduit 406 preferably extends by at least one, more preferably three and more preferably at least around six diameters in extent (e.g. 843 in FIG. 12c). Extent here is intended to mean a length of the electrolyte conduit 406. Where the electrolyte conduit 406 has a non-circular cross section, the extent of the conduit may be defined in terms of a major dimension through a cross-section of the conduit (e.g. a diameter, in the case of a circular pipe).

The incorporation of the electrolyte conduit 406 provides a number of advantages. Firstly, the electrolyte conduit 406 provides a heat sink functionality by increasing the surface area of conductive material in thermal communication with the bulk of the rest of the mounting body 402. As such, during electrochemical machining where, for example, 1000 A may be passed through the mounting body 402 via the busbar 414, the electrolyte conduit 406 assists in providing a heat sink functionality to cool the overall electrode assembly 400 and the electrolyte flowing therethrough. A further advantage is that the electrolyte conduit 406 provides a more uniform flow of electrolyte through the mounting body 402 and around the first conductive element 408. As already described, a uniform, and reduced turbulence, flow of electrolyte is desirable for reasons of improved efficiency of electrochemical machining. This is particularly advantageous where the electrolyte conduit 406 is axial in nature (i.e. straight) and is substantially normal to the rear surface 432 of the mounting body 402. A further advantage provided by the electrolyte conduit 406 is that as electrolyte flows through the conduit 406, by virtue of the electrolyte conduit 406 being electrically connected (e.g. by virtue of being integral with the mounting body 402) the electrolyte is effectively charged as it moves through the conduit. The electrolyte conduit 406 can therefore be considered to form part of an overall cathode of which the mounting body 402 forms part (including the integral busbar 414 and the first conductive element 402). Charge is therefore transferred to the electrolyte, and the electrolyte is precharged before it actually meets the first conductive element 408 (e.g. before the electrolyte flow enters the electrolyte channels 416, 418, 420, 422). This has advantageously been found to improve the quality of machining as the electrolyte is expelled from the electrolyte channels (visible in FIG. 12a) around the first conductive element 408. The precharging is achieved by increasing the contact time for which the electrolyte passes through electrically charged surrounding surfaces.

For at least the reasons set out above, incorporation of the electrolyte conduit 406 provides a number of different benefits for the mounting body 402 and the electrode assembly 400 more generally.

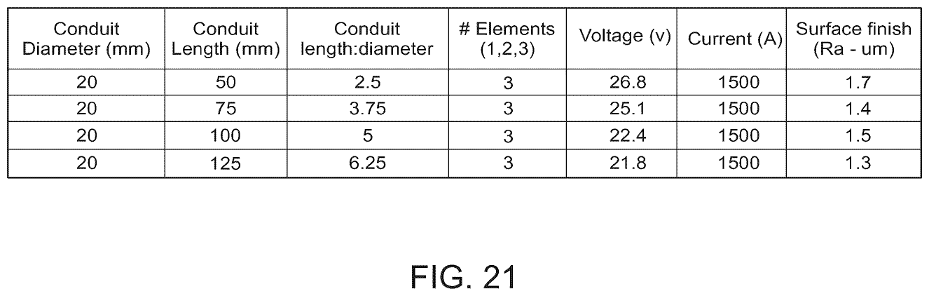

Also shown extending partway through the mounting body 402 is a bore 834. The bore 834 is configured to receive an urging means in the form of a flexible element (e.g. a cord) therethrough to be able to transition the electrode 404 from a moveable configuration (e.g. as shown in FIG. 12b) to a conforming configuration (e.g. as shown in FIG. 21).

A clearance, or gap, 819 exists between a perimeter 821 of the first conductive element 408 and an outer edge 823 of the electrolyte channels. This clearance is preferably between around 4 mm and around 6 mm. The outer edge 823 of the electrolyte channels preferably matches the opening which defines the internal cavity to be machined.

Turning to FIG. 12c, a perspective cross-section view of part of the electrode assembly 400 shown in FIGS. 12a and b is provided. The FIG. 12c view is taken about the cross-section labelled 836 in FIG. 12b.

Beginning first with the electrolyte conduit 406, as mentioned above in the illustrated embodiment the electrolyte conduit 406 is a circular pipe having a circular cross-section. A major dimension of the cross-section of the electrolyte conduit 406 is therefore defined by a diameter 440 in the illustrated embodiment. Specifically, the major dimension is defined by an internal diameter 440. The electrolyte conduit 406 has an extent, or length, 843 (which is parallel to the axis 442 in the illustrated embodiment). The extent 843 of the conduit 406 spans from the upstream end 438 to the upstream end 429 of the electrolyte channels 16, 418, 420, 422 in the Illustrated embodiment. As mentioned above, the extent 843 of the electrolyte conduit 406 is entirely axial in the illustrated embodiment (i.e. straight) but in other embodiments an arcuate section may be incorporated. Similarly, the axis 442 is normal to the rear face 432, and the engagement face 433, of the mounting body 402. The axis 442 is also normal to an opening that defines the internal cavity that is machined by the electrochemical machining process.

In use, electrolyte is fed through the electrolyte conduit 406 from an upstream end 438. The electrolyte then flows through the electrolyte conduit 406 as indicated by directional arrow 444. Importantly, owing to the axial nature of the electronic conduit 406, and the orientation of the conduit 406 relative to the rear face 432 of the mounting body 402, electrolyte flow 404 through the conduit 406 is relatively uniform and lamina.

At a downstream end of the electrolyte conduit 406, the flow of electrolyte 444 is then divided between the plurality of electrolyte channels 416, 418, 420, 422. The first and second electrolyte channels 416, 418 are shown in cross-section, with the third and fourth channels 420, 422 partially obscured from view (although an upstream end is partially visible). As shown in FIG. 12c, each of the electrolyte channels 416, 418, 420, 422 is defined by one or more of the plurality of ribs 424, 426, 428, 430. For example, the first electrolyte channel 416 (in the upper left hand quadrant of FIG. 12c) is defined by a combination of the first and fourth ribs 424, 430. Each of the first to fourth ribs 424, 426, 428, 430 has a reduced cross-sectional area at an upstream end. Described another way, each of the ribs 424, 426, 428, 430 may be said to be tapered (e.g. chamfered). Advantageously this improves the guiding of electrolyte flow over the ribs 424, 426, 428, 430 and through the electrolyte channels 416, 418, 420, 422.

Electrolyte is delivered to the upstream end 438 of the electrolyte conduit 406 via another electrolyte supply (not shown). Said electrolyte supply may take the form of a conduit, preferably a non-conductive (e.g. insulating) conduit.

When FIG. 12c is considered in combination with FIG. 12a, it will be appreciated that the electrolyte channels 416, 418, 420, 422 take the form of generally arcuate cavities, particularly downstream ends thereof (e.g. 431). The arcuate cavities may otherwise be described as arcuate apertures at the downstream ends 431 of the electrolyte channels 416, 418, 420, 422. Furthermore, the electrolyte channels 416, 418, 420, 422, again specifically downstream ends 431 thereof, are distributed around the first conductive element 408 and generally conform to a perimeter thereof. The electrolyte channels 416, 418, 420, 422 are also evenly distributed around an entire perimeter of the first conductive element 408. The electrolyte channels 416, 418, 420, 422 also generally increase in cross-sectional area from an upstream end 429 to a downstream end 431, such that the electrolyte flow therethrough can be described as diffusing.

Returning to FIG. 12c, it will also be appreciated that the first conductive element 408 is coupled to each of the plurality of ribs 424, 426, 428, 430432. Described another way, the first conductive element 408 is effectively connected to the mounting body 402 via the ribs 424, 426, 428, 430432. Furthermore, as previously described, the first conductive element 408 is integral with the mounting body 402.

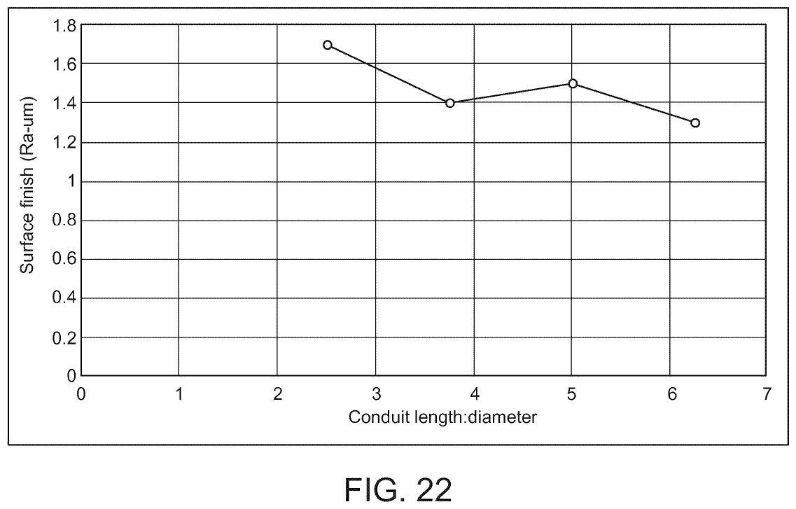

Although there are four electrolyte channels 416, 418, 420, 422 in the illustrated embodiment, it will be appreciated that there may be more, or fewer, electrolyte channels. For example, two or three electrolyte channels could otherwise be incorporated. Similarly, five or more electrolyte channels could otherwise be used. Furthermore, and returning to FIG. 12a, the electrolyte channels 416, 418, 420, 422 are evenly distributed around an entire perimeter of the first conductive element 408. In other embodiments the electrolyte channels 416, 418, 420, 422 may only be distributed around part of a perimeter of the electrode, and/or may extend through part of the electrode (e.g. as shown in FIGS. 22 to 25).

In the illustrated embodiment each of the electrolyte channels 416, 418, 420, 422 extends entirely through a main block of the mounting body 402 (e.g. between the engagement face 433 and the rear face 432). In other embodiments, the electrolyte channels may not extend through such an extent of the mounting body 402. However, it is preferred that the downstream ends 431 of the plurality of electrolyte channels 416, 418, 420, 422 open out through the engagement face 433 of the mounting body 402.

Finally, FIG. 12c also shows part of a passage 444 through which the urging means, in the form of a flexible element (e.g. a cord) extends through the electrode 404. Although not shown in FIG. 12c, in preferred embodiments that passage also extends through a rib (e.g. the first rib 424) and through the bore 834 (as shown in FIG. 12b).

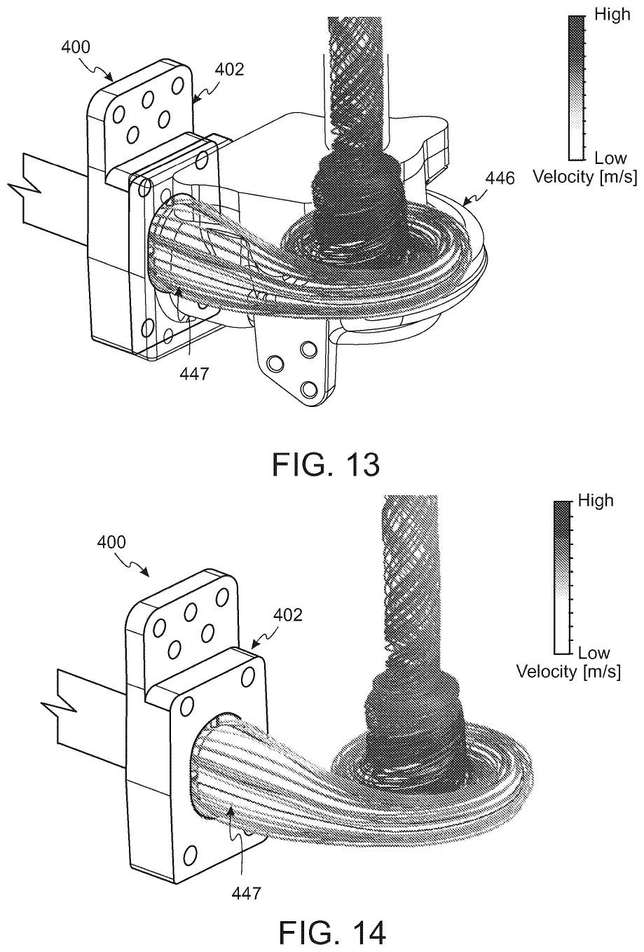

Turning to FIGS. 13 and 14, the results of CFD simulations conducted on the electrode assembly 400 of FIGS. 12a-c are shown. The results show velocity contour plots of the route taken by electrolyte upon expulsion from the mounting body 402 into a component to be machined (a turbine housing 446 in this instance, as shown in FIG. 13). When FIGS. 13 and 14 are compared with FIGS. 9 and 10, it will be appreciated that the electrolyte is expelled from the mounting body in a much more uniform manner than that shown in FIGS. 9 and 10. In particular, in a region 447 proximate an upstream end of the cavity to be machined, the contour lines are entirely separate from one another, absent any recirculation, and follow the outer electrode surface of the first conductive element. This is desirable electrolyte behaviour, as previously described, for the reason that a uniform and less turbulent flow of electrolyte, with little or no recirculation, provide uniform and efficient electrochemical machining. Efficient electrochemical machining may refer to a desirable surface finish being achieved in a low process time (e.g. cycle time). The inventors have also found that the uniformity of the velocity distribution is an important factor for electrochemical machining. The increase in cross-section of the electrolyte channels through the mounting body 402 also provides a more uniform flow of electrolyte (e.g. avoids localised areas of high velocity jets where electrolyte may otherwise have been expelled through comparatively small bores).

It is desirable to improve the efficiency of electrochemical machining generally for the reason that the power requirement can then be reduced (e.g. resulting in lower operating costs). Cooling requirements are also reduced. By reducing the cooling requirement, electrolyte can be pumped at a lower flowrate which, in turn, reduces the risk of turbulent flow disrupting the electrochemical machining process. The electrolyte flowrate is balanced to provide a desirable level of ‘flushing’ of machined material whilst avoiding the formation of turbulent eddy currents in the flow. An electrolyte flowrate of around 22 litres per minute has been found to be particularly effective.

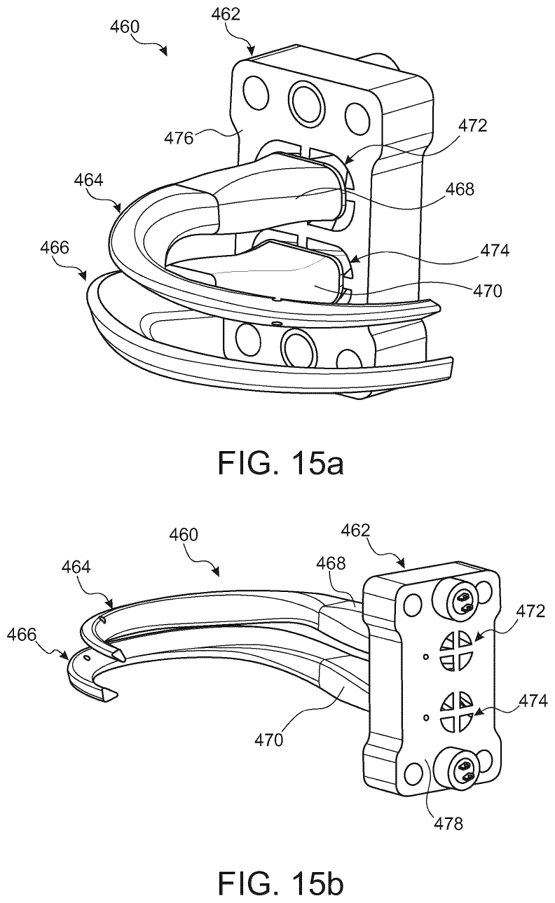

FIG. 15a is a perspective view of an electrode assembly 460 according to another embodiment. FIG. 15a is taken generally from an engagement face 476 side of the assembly, with FIG. 15b taken generally from a rear side 478. The electrode assembly 460 shares many features in common with the electrode assembly 400 described in detail in connection with FIGS. 12a to c, and only the differences will be described in detail.

The electrode assembly 460 comprises a mounting body 462 and first and second electrodes 464, 866. First conductive elements 468, 470 of the first and second electrodes 464, 466 respectively are coupled to, and integral with, the mounting body 462. In FIGS. 15a and 15b regions of the electrodes 464, 466 beyond the first conductive elements 468, 470 are modelled as single pieces for ease of illustration, although in practice the electrodes 464, 466 each comprise a plurality of conductive elements as described elsewhere in this document.

Distributed around each of the first conductive elements 468, 470 are respective first and second pluralities of electrolyte channels 472, 474. Save for the fact that there is a second electrode 466 and a second plurality of electrolyte channels 474, many of the other features, particularly in connection with the electrolyte channels, are the same as those described in connection with the electrode assembly 400 of FIGS. 12a to c.

Turning to FIG. 15b, as mentioned above a view generally of a rear face 478 of the electrode assembly 460 is provided. FIG. 15b illustrates how the first and second pluralities of electrolyte channels 472, 474 extend through an entire thickness of the mounting body 402 (e.g. between the engagement face 476 [as labelled in FIG. 15a] and the rear face 478). Based on FIGS. 15a and 15b it will be appreciated that each of the first and second arrays of electrolyte channels 472, 574 are distributed evenly around an entire perimeter of each of the first and second electrodes 464, 466 respectively. That is to say, the first plurality of electrolyte channels 472, specifically downstream ends thereof, are distributed around the first conductive element 468. Similarly, the second plurality of electrolyte channels 474, specifically downstream ends thereof, are distributed around the second conductive element 470. Although two electrodes 464, 466 are incorporated in the illustrated embodiment, it will be appreciated that fewer, or more, electrodes may otherwise be incorporated in other embodiments. A plurality of electrolyte channels are preferably distributed around each electrode where the assembly comprises more than one electrode.

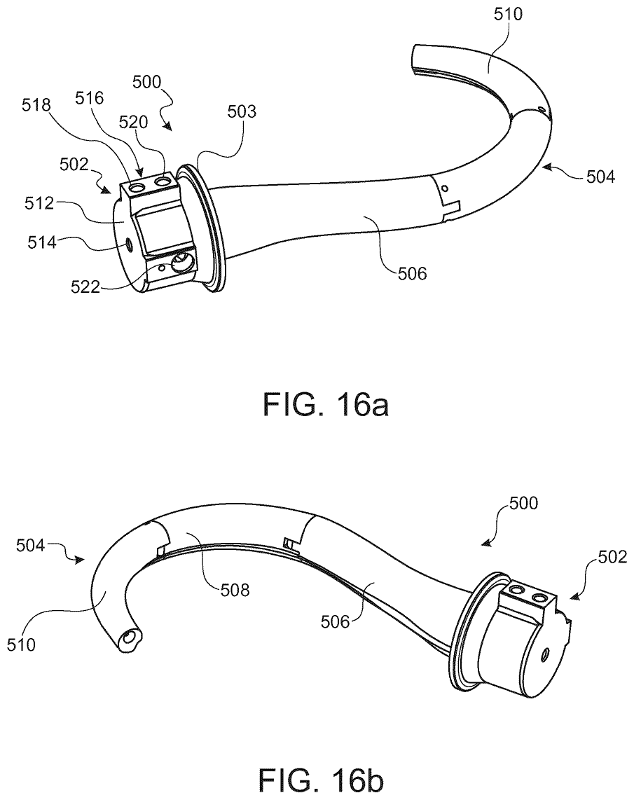

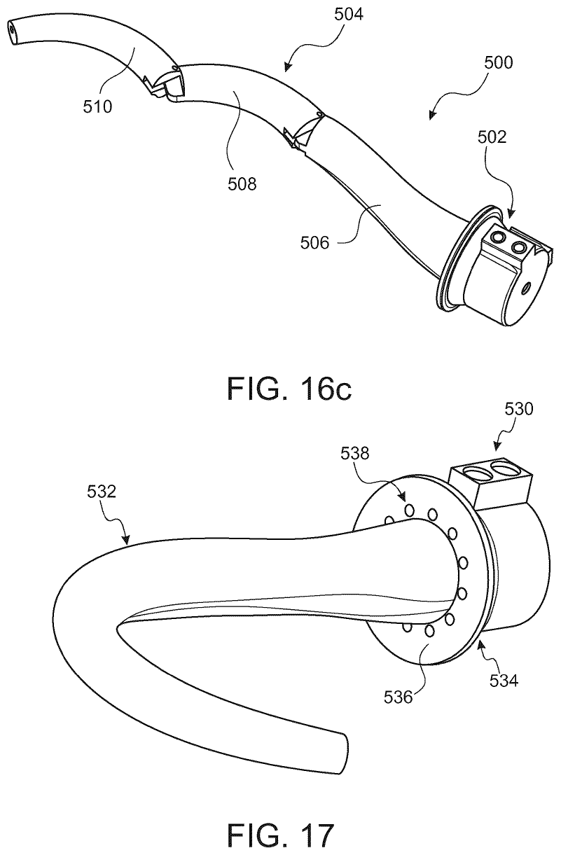

Turning to FIGS. 16a and b, an electrode assembly 500 according to another embodiment is provided. Whereas many of the prior electrode assemblies have been for machining turbine housings, the electrode assembly 500500 is for machining a compressor housing instead.

Many of the core features of the electrode assembly 500 are common to the prior embodiments. For example, the electrode assembly 500 comprises a mounting body 502 having an engagement face 503 engageable with the compressor housing to align the mounting body 502 with the housing. The electrode assembly 500 further comprises an electrode 504 comprising first, second and third conductive elements 506, 508, 510. The electrode 504 is shown in a conforming configuration in FIGS. 16a and b but in a moveable configuration in FIG. 16c.

A rear face 512 of the mounting body 502 comprises a bore 514 through which urging means, e.g. in the form of a flexible element such as a cord, is receivable to transition the electrode 504 from the moveable configuration to the conforming configuration. The mounting body 502 further comprises an integral busbar 516 which comprises first and second sockets 518, 520 for electrically connecting the mounting body 502, and electrode 504, to a power supply. The mounting body 502 further comprises an electrolyte conduit 522 integral with the mounting body 502 and configured to receive electrolyte therethrough. Downstream electrolyte channels are shown and described in connection with FIG. 17 (which, for completeness, relates to a slightly different embodiment of electrode assembly).

FIG. 16b is a different perspective view of the electrode assembly 500. FIG. 16c is shows the electrode assembly 500 with the electrode 504 in a movable configuration.

FIG. 17 is a perspective view of an electrode assembly 530 according to another embodiment. The electrode assembly 530 shares many features in common with the electrode assembly 500 of FIGS. 16a to c and only the differences will be described in detail.

Firstly, the electrode 532 of the electrode assembly 530 is a single, rigid body. Described another way, the electrode 532 is fixedly attached to mounting body 534 such that there is no relative movement therebetween. The electrode assembly 500 may therefore be described as a single-piece apparatus.

The electrode assembly 530 comprises a mounting body 534. Distributed around an engagement face 536 of the mounting body 532 are a plurality of electrolyte channels 538. The plurality of electrolyte channels 538, specifically downstream ends thereof, are bores which are evenly, and continuously, distributed around the electrode 532 proximate the mounting body 534. The plurality of electrolyte channels 538 are therefore circumferentially distributed around, and offset from, the electrode 532.

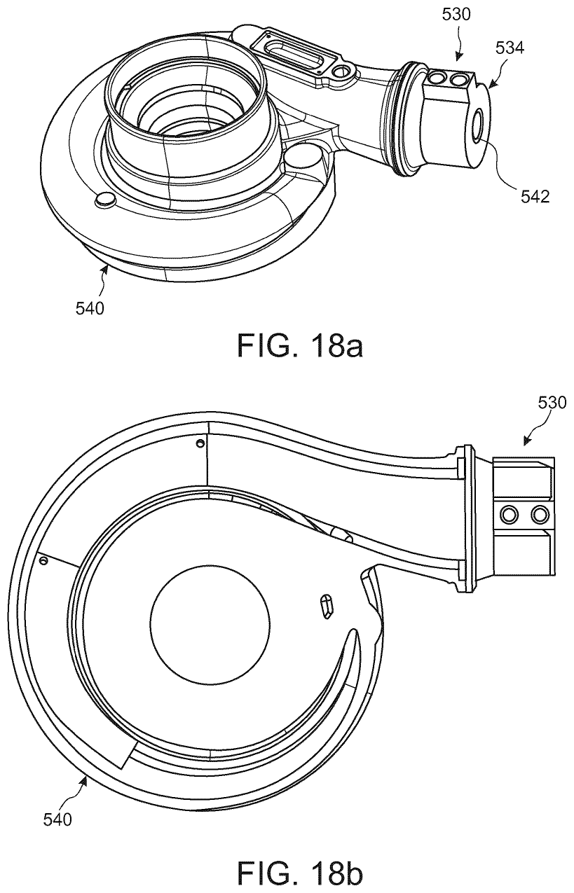

Turning to FIGS. 18a and b, a perspective view of the electrode assembly 530 of FIG. 17 installed in situ and coupled to a compressor housing 540 is shown. FIG. 18a also shows an electrolyte conduit 542, an axial conduit integral with, and extending partway through, the mounting body 534. Advantageously, the incorporation of the axial electrolyte conduit 542 reduces electrolyte flow disruption and provides a reduced turbulence flow of electrolyte into a volute of the compressor housing 540 during electrochemical machining, as well as precharging the electrolyte. The electrolyte conduit 542 in FIG. 18a may be described as an internal conduit in that it can be considered to extend within the mounting body 534. Given that the electrode is fixedly attached to the mounting body 534 in this embodiment, it will be appreciated that partial disassembly of the compressor housing 540 may be needed in order to position the electrode within the volute.

FIG. 18b is a partially cut-away plan view showing the electrode assembly 530 extending through the volute of the compressor housing 540.

For the avoidance of doubt, whilst the illustrated embodiments show the use of mounting bodies in combination with a multi-piece electrode (e.g. comprising a plurality of conductive elements having a movable and conforming configuration), the benefits obtained from uniform electrolyte distribution (e.g. the incorporation of a plurality of electrolyte channels) and precharging the electrolyte (e.g. incorporating an electrically connected electrolyte conduit) are independent of the variety of electrode used. For example, the same benefits would be obtained in an embodiment in which a flexible electrode, comprising a flexible core and a plurality of conductive and non-conductive disks attached thereto, was used. Similarly, the same benefits would be obtained in a further embodiment in which a flexible electrode comprises a flexible core, a plurality of elongate conductive segments attached thereto and a plurality of non-conductive rollers rotatably attached to an exterior of the segments. Furthermore, it will be appreciated that benefits would also be obtained if the electrode was a single, rigid electrode fixedly attached to the mounting body.

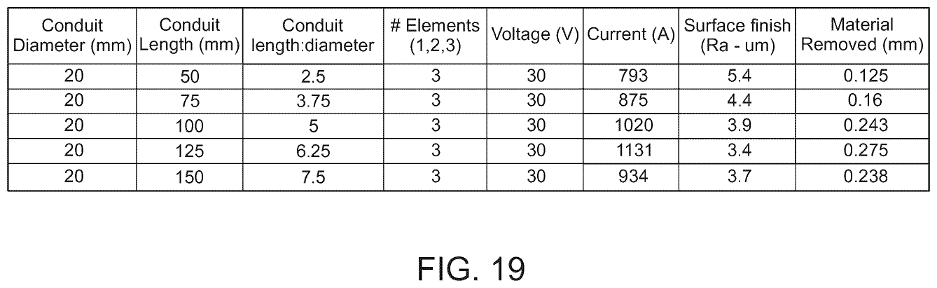

FIG. 19 is a table of experimental data obtained using the electrode assembly 400 of FIGS. 12a to c when a turbine housing is machined.

As indicated in FIG. 19, the supply voltage was held constant at 30 V across all tests. The tests were therefore voltage-driven tests. The length, or extent, of the conduit 406 (FIG. 12a) was varied and the resulting effect upon the electrochemical machining process was recorded. The effect was ascertained by measuring the surface finish of a turbine housing machined using the process (using a manual measurement—a stylus at an inlet of the turbine housing), as well as the amount of material removed (again a manual measurement—callipers across the inlet).

As indicated by the table of FIG. 19, a conduit length:diameter ratio of ˜6 provided the best surface finish with the machining process having removed the most material from the turbine housing. As shown in FIG. 20, which is a plot of the FIG. 19 data (with surface finish plotted on the Y axis), the best surface finish is obtained in embodiments where the extent of the conduit is at least around 6 diameters. This is considered to be due to a combination of the conduit extent providing uniform flow, as well as a precharging effect upon the electrolyte.

FIG. 21 is a table of experimental data obtained using the electrode assembly 400 of FIGS. 12a to c when a compressor housing is machined.

As indicated in FIG. 21, the current supply was held constant at 1500 A across all tests. The tests were therefore current-driven tests. Again, the length, or extent, of the conduit 406 (FIG. 12a) was varied and the resulting effect upon the electrochemical machining process was recorded.

As indicated by the table of FIG. 21, a conduit length:diameter ratio of ˜6 again provided the best surface finish with the machining process having removed the most material from the compressor housing. As shown in FIG. 22, which is a plot of the FIG. 21 data (with surface finish plotted on the Y axis), the best surface finish is obtained in embodiments where the extent of the conduit is around 6 diameters. This is considered to be due to a combination of the conduit extent providing uniform flow, as well as a precharging effect upon the electrolyte.

FIG. 23 is a plot showing the effect of the conduit extent, in diameters, (X axis) upon the Reynolds number (Y axis) of electrolyte flow for the electrode assembly 400 of FIGS. 12a to c. The Reynolds number is manually calculated based upon the results of CFD simulation data (in which the velocity of electrolyte at a given point within the turbine housing is obtained from the simulation data). FIG. 23 indicates that the Reynolds number of electrolyte flow generally reduces from around 1 to around 6 conduit extends, at which point the variation generally reduces. This is also indicated by the dashed trend line. FIG. 23 therefore indicates that a conduit extent of around six diameters is a desirable embodiment for reasons of reduced turbulence.

Throughout this document, any electrode is preferably held (e.g. fixed) stationary whilst electrochemical machining occurs. That is to say, relative movement between the electrode and the cavity being machined is substantially prevented. Similarly, any component, the subject of machining, is preferably held stationary whilst machining occurs.

Electrochemical machining may otherwise be referred to as reverse electroplating in that material is removed, rather than being added (as is the case for electroplating). The polarity of the electrode and workpiece may also be reversed in comparison to electroplating.

Reducing a gap between the conductive body and the internal wall may provide a more significant, or stronger, magnitude of machining.

The compressor housing may be referred to as a compressor cover.

Where the component is a turbine housing, the manufacture process may be:
1. Sand moulding for initial casting geometry;
2. Shot blasting of cast geometry;
3 Gates/runners ground off;
4. Electrochemical machining process, as described in this document;
5. Cosmetic blast.

Examples according to the disclosure may be formed using an additive manufacturing process. A common example of additive manufacturing is 3D printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modeling (FDM), Selective Laser Sintering (SLS), Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes. Binder Jetting is a preferred process for manufacturing the conductive elements, and electrodes, described in this application.

The additive manufacturing processes described herein may be used for forming components using any suitable material. For example, the material may be metal, composite or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in additive manufacturing processes which may be suitable for the fabrication of examples described herein. Stainless steel 316 A/L is a preferred material for manufacturing the mounting body, conductive elements, and electrodes, described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on three-dimensional (3D) information, for example a three-dimensional computer model (or design file), of the component.

Accordingly, examples described herein not only include products or components as described herein, but also methods of manufacturing such products or components via additive manufacturing and computer software, firmware or hardware for controlling the manufacture of such products via additive manufacturing. The structure of one or more parts of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (0.3 mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus can be instructed to print out one or more parts of the product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

The described and illustrated embodiments are to be considered as illustrative and not restrictive in character, it being understood that only preferred embodiments have been shown and described and that all changes and modifications that come within the scope of the inventions as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

1. A mounting body for electrochemically machining a cavity of a component, the mounting body comprising:
an engagement face engageable with the component to align the mounting body with the component;
at least part of an electrode coupled to the mounting body; and
a plurality of electrolyte channels which extend at least partway through the mounting body;
wherein downstream ends of the plurality of electrolyte channels are distributed around the at least part of an electrode.

2. The mounting body of claim 1, wherein the downstream ends of the plurality of electrolyte channels are evenly distributed around the electrode.

3. The mounting body of claim 1, wherein the downstream ends of the plurality of electrolyte channels are offset from the electrode.

4. The mounting body of claim 1, wherein the plurality of electrolyte channels extend through the electrode.

5. The mounting body of claim 1, wherein the electrolyte channels vary in cross-sectional area from an upstream end to the downstream end.

6. The mounting body of claim 1, wherein the electrolyte channels are defined by one or more ribs.

7. The mounting body of claim 6, wherein the at least part of an electrode is coupled to the one or more ribs.

8. The mounting body of claim 1, wherein the at least part of an electrode is integral with the mounting body.

9. The mounting body of claim 1, further comprising an electrolyte conduit located upstream of, and in fluid communication with, the plurality of electrolyte channels.

10. The mounting body of claim 9, wherein the electrolyte conduit has an extent of at least around six major dimensions of a cross-section of the conduit.

11. A method of electrochemically machining a cavity of a component using the mounting body according to any preceding claim, the method comprising:
coupling the mounting body to the component to align the at least part of an electrode within the cavity; and
applying a negative charge to the at least part of an electrode, and providing a flow of electrolyte through the plurality of electrolyte channels to distribute electrolyte around the at least part of an electrode and remove material from an internal wall of the cavity.

12. The method of claim 11, wherein the electrolyte comprises a liquid electrolyte.

13. The method of claim 11, wherein the electrolyte comprises a plurality of bodies.

14. A mounting body for electrochemically machining a cavity of a component, the mounting body comprising:
an engagement face engageable with the component to align the mounting body with the component; and
an electrolyte conduit configured to receive a flow of electrolyte;
wherein the electrolyte conduit has an extent of at least around one major dimension of a cross-section of the conduit; and
wherein the electrolyte conduit is electrically connected to the mounting body.

15. The mounting body of claim 14, wherein the electrolyte conduit is integral with the mounting body.

16. The mounting body of claim 14, wherein the electrolyte conduit has an extent of at least around three major dimensions of a cross-section of the conduit.

17. The mounting body of claim 16, wherein the electrolyte conduit has an extent of at least around six major dimensions of a cross-section of the conduit.

18. The mounting body of claim 14, wherein the mounting body and electrolyte conduit are manufactured from the same material.

19. The mounting body of claim 14, wherein the electrolyte conduit is axial in extent.

20. The mounting body of claim 14, further comprising at least part of an electrode coupled to the mounting body.

21. The mounting body of claim 1, further comprising a plurality of electrolyte channels that extend at least partway through the mounting body, the plurality of electrolyte channels being provided downstream of the electrolyte conduit.

22. The mounting body of claim 21 when dependent upon claim 20, wherein downstream ends of the plurality of electrolyte channels are distributed around the at least part of an electrode.

23. A method of electrochemically machining a cavity of a component using the mounting body of claim 14, the method comprising:
applying a negative charge to the mounting body, and so the electrolyte conduit, and providing a flow of electrolyte through the electrolyte conduit;
precharging the electrolyte as it flows through the electrolyte conduit towards the cavity; and
expelling the precharged electrolyte into the cavity to remove material from an internal wall of the cavity.

24. The method of claim 23, wherein the electrolyte comprises a liquid electrolyte.

25. The method of claim 23, wherein the electrolyte comprises a plurality of bodies.

26. The mounting body of claim 1, wherein the component is a turbine housing or a compressor housing for a turbocharger, and wherein the cavity is a turbine housing volute or a compressor housing volute respectively.

27. A computer program comprising computer executable instructions that, when executed by a processor, cause the processor to control an additive manufacturing apparatus to manufacture the mounting body of claim 1.

28. A method of manufacturing an electrode, or a conductive element thereof, via additive manufacturing, the method comprising:
obtaining an electronic file representing a geometry of the mounting body of claim 1; and
controlling an additive manufacturing apparatus to manufacture, over one or more additive manufacturing steps, the electrode, or a conductive element thereof, according to the geometry specified in the electronic file.

29. A component comprising a cavity electrochemically machined using the mounting body of claim 1.
